(19) United States
(12) Patent Application Publication
(10) Pub. No.: US 2019/0053218 A1
(43) Pub. Date: Feb. 14, 2019

(54) METHOD FOR TRANSMITTING AND RECEIVING UPLINK CONTROL INFORMATION IN MOBILE COMMUNICATION SYSTEM, AND APPARATUS FOR THE SAME

(71) Applicant: ELECTRONICS AND TELECOMMUNICATIONS RESEARCH INSTITUTE, Daejeon (KR)

(72) Inventors: Cheul Soon KIM, Daejeon (KR); Sung Hyun MOON, Daejeon (KR); Jung Hoon LEE, Daejeon (KR)

(21) Appl. No.: 16/058,187

(22) Filed: Aug. 8, 2018

(30) Foreign Application Priority Data
Aug. 10, 2017 (KR) 10-2017-0101413
Nov. 3, 2017 (KR) 10-2017-0146031
Nov. 17, 2017 (KR) 10-2017-0154209
Feb. 2, 2018 (KR) 10-2018-0013631
Jul. 24, 2018 (KR) 10-2018-0085795

(51) Int. Cl. H04W 72/04; H04W 76/27; H04L 1/18; H04L 5/00

(52) U.S. Cl. CPC H04W 72/0413; H04W 76/27; H04L 5/0044; H04L 5/0055; H04L 5/0048; H04L 1/1812

(57) ABSTRACT

An operation method of a terminal for transmitting uplink control information (UCI) to a base station by multiplexing two or more UCIs in a single physical uplink control channel (PUCCH) includes: determining a first sequence corresponding to a value of a second UCI (UCI2) when the UCI2 is generated before completing transmission of a first UCI (UCI1) to the base station; modulating the first sequence by applying a modulation symbol corresponding to a value of the UCI1, and applying a orthogonal cover code (OCC) to the modulated first sequence to generate a second sequence; and transmitting the second sequence in at least one symbol position of symbols constituting the PUCCH.

### CROSS-REFERENCE TO RELATED APPLICATIONS

This application claims priorities to Korean Patent Applications No. 10-2017-0101413, filed Aug. 10, 2017, No. 10-2017-0146031, filed Nov. 3, 2017, No. 10-2017-0154209, filed Nov. 17, 2017, No. 10-2018-0013631, filed Feb. 2, 2018, and No. 10-2018-0085795, filed Jul. 24, 2018, in the Korean Intellectual Property Office (KIPO), the entire contents of which are, hereby incorporated by reference.

### BACKGROUND

### 1. Technical Field

The present disclosure relates to a mobile communication system, more specifically, to a method and an apparatus for transmitting and receiving uplink control information in a mobile communication system.

### 2. Description of Related Art

In case of carrier'aggregation (CA) where two or more component carriers (CCs) are configured in a terminal, in case that two or more bandwidth parts (BWPs) are configured in a terminal, or in ease that two or more traffics are transmitted as multiplexed, a case may occur in which two or more uplink control information (UCI) having different priorities should be transmitted through a long physical uplink control channel (PUCCH) and a short PUCCH.

In these cases, a method of puncturing some resources of the long PUCCH, or a method of performing rate matching of the UCI transmitted on the short PUCCH with the UCI transmitted on the long PUCCH may be used to transmit both the UCIs. However, there is not yet a method of multiplexing and transmitting a long PUCCH and a short PUCCH, simultaneously satisfying low error rates and low-latency requirements.

### SUMMARY

Accordingly, embodiments of the present disclosure provide an operation method of a terminal for multiplexing two or more UCIs into a single PUCCH and transmitting the PUCCH to a base station.

Accordingly, embodiments of the present disclosure also provide an operation method of a base station for receiving two or more UCIs multiplexed into a single PUCCH from a terminal.

Accordingly, embodiments of the present disclosure also provide a terminal for multiplexing two or more UCIs into a single PUCCH and transmitting the PUCCH to a base station.

In order to achieve the objective of the present disclosure, an operation method of a terminal for transmitting uplink control information (UCI) to a base station by multiplexing two or more UCIs in a single physical uplink control channel (PUCCH) may comprise determining a first sequence corresponding to a value of a second UCI (UCI2) when the UCI2 is generated before completing transmission of a first UCI (UCI1) to the base station; modulating the first sequence by applying a modulation symbol corresponding to a value of the UCI1, and applying a orthogonal cover code (OCC) to the modulated first sequence to generate a second sequence; and transmitting the second sequence in at least one symbol position of symbols constituting the PUCCH.

The first sequence may be determined by applying a cyclic shift corresponding to the value of the UCI2 to a base sequence selected based on a value received from the base station via a radio resource control (RRC) signaling and/or a downlink control information (DCI).

The UCI2 may be a hybrid automatic repeat request acknowledgement (HARQ-ACK) information for a ultra-reliable low-latency communication (URLLC) physical downlink shared channel (PDSCH), when the UCI1 is a HARQ-ACK information for an enhanced mobile broadband (eMBB) PDSCH.

The at least one symbol position may be indicated by the base station via a RRC signaling, or may be selected by a downlink control information (DCI) among two or more values indicated via a RRC signaling.

The PUCCH may be a long PUCCH structure in which demodulation reference (DM-RS) symbols and UCI payload symbols are located alternately.

The at least one symbol position may indicate one of the UCI payload symbols, and the second sequence may be transmitted together with a DM-RS sequence in a position of the one of UCI payload symbols.

The at least one symbol position may indicate one of the UCI payload symbols, the second sequence may be transmitted in a position of the one of the UCI payload symbols, and the second sequence performs a role of DM-RS.

The at least one symbol position may indicate one of the DM-RS symbols and one of the UCI payload symbols, a long PUCCH DM-RS sequence to which a cyclic shift corresponding to the value of the UCI2 is applied may be transmitted in a position of the one of the DM-RS symbols, and the second sequence may be transmitted in a position of the one of the UCI payload symbols.

In order to achieve the objective of the present disclosure, an operation method of a base station for receiving two or more UCIs multiplexed in a single PUCCH from a terminal may comprise receiving a signal of the PUCCH from the terminal; attempting to detect a long PUCCH demodulation reference signal (DM-RS) from the signal of the PUCCH; detecting a second UCI (UCI2) by detecting a sequence corresponding to the UCI2 from at least one symbol position of symbols constituting the PUCCH, when the long PUCCH DM-RS is detected; and detecting a first UCI (UCI1) by despreading the signal of the PUCCH and demultiplexing the UCI1 by using an orthogonal cover code (OCC) applied to the UCI1, when the UCI1 is detected.

The UCI2 may be a HARQ-ACK information for a URLLC PDSCH, when the UCI1 is a HARQ-ACK information for an eMBB PDSCH.

The PUCCH may have a long PUCCH structure in which demodulation reference (DM-RS) symbols and UCI payload symbols are located alternately.

The at least one symbol position may indicate one of the UCI payload symbols, and the sequence corresponding to the UCI2 may be detected together with a DM-RS sequence in a position of the one of UCI payload symbols.

The at least one symbol position may indicate one of the UCI payload symbols, the sequence corresponding to the UCI2 may be detected in a position of the one of the UCI payload symbols, and the sequence corresponding to the UCI2 may perform a role of DM-RS.

The at least one symbol position may indicate one of the DM-RS symbols and one of the UCI payload symbols, a long PUCCH DM-RS sequence to which a cyclic shift corresponding to the value of the UCI2 is applied may be detected at a position of the one of the DM-RS symbols, and the sequence corresponding to the UCI2 may be detected in a position of the one of the UCI payload symbols.

In order to achieve the objective of the present disclosure, a terminal for transmitting UCI to a base station by multiplexing two or more UCIs in a single PUCCH may comprise at least one processor, a memory storing at least one instruction executed by the at least one processor, and a transceiver controlled by the at least one processor. Also, the at least one instruction may be configured to cause the at least one processor to determine a first sequence corresponding to a value of a second UCI (UCI2) when the UCI2 is generated before completing transmission of a first UCI (UCI1) to the base station; modulate the first sequence by applying a modulation symbol corresponding to a value of the UCI1, and apply a orthogonal cover code (OCC) to the modulated first sequence to generate a second sequence; and transmit the second sequence in at least one symbol position of symbols constituting the PUCCH through the transceiver.

The first sequence may be determined by applying a cyclic shift corresponding to the value of the UCI2 to a base sequence selected based on a value received from the base station via a radio resource control (RRC) signaling and/or a downlink control information (DCI).

The UCI2 may be a HARQ-ACK information for a URLLC PDSCH, when the UCH is a HARQ-ACK information for an eMBB PDSCH.

The PUCCH may have a long PUCCH structure in which demodulation reference (DM-RS) symbols and UCI payload symbols are located alternately.

The at least one symbol position may indicate one of UCI payload symbols, and the second sequence may be transmitted together with a DM-RS sequence in a position of the one of UCI payload symbols, or transmitted in a position of the one of the UCI payload symbols by performing a role of DM-RS.

The at least one symbol position may indicate one of the DM-RS symbols and one of the UCI payload symbols, a long PUCCH DM-RS sequence to which a cyclic shift corresponding to the value of the UCI2 is applied may be transmitted in a position of the one of the DM-RS symbols, and the second sequence may be transmitted in a position of the one of the UCI payload symbols.

Using the methods for transmitting and receiving UCIs according to the embodiments of the present disclosure, two or more UCIs can be transmitted as multiplexed on a single PUCCH or transmitted in one slot in a time division multiplexing (TDM) manner. Thus, a low error rate can be maintained while meeting low-latency requirements of the fifth generation mobile communication system.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a mobile communication system according to a first embodiment of the present disclosure;

FIG. 2 is a block diagram illustrating a communication node in a mobile communication system according to a first embodiment of the present disclosure;

FIG. 3 is a conceptual diagram illustrating an example of a relationship between UL data traffics, physical resources, and scheduling requests;

FIGS. 4A and 4B are conceptual diagrams for explaining a processing method of UCI2 according to a generation time point of UCI2;

FIGS. 5A to 5C are conceptual diagrams for explaining cases of multiplexing and transmitting PUCCHs in a TDM manner;

FIGS. 6A and 6B are conceptual diagrams for explaining cases in which a transient gap at the boundary of PUCCHs exists within a symbol duration;

FIGS. 7A and 7B are conceptual diagrams for explaining cases in which a transient time at the boundary of PUCCHs exists outside a symbol duration;

FIG. 8 is a flowchart illustrating a method of multiplexing and transmitting a short PUCCH in a long PUCCH at a UE according to an embodiment of the present disclosure;

FIG. 9 is a flowchart illustrating a method of receiving a long PUCCH in which a short PUCCH is multiplexed at a base station according to an embodiment of the present disclosure;

FIGS. 10A to 10D are conceptual diagrams for explaining resource structures when a long PUCCH and a short PUCCH are multiplexed according to an embodiment of the present disclosure;

FIGS. 11A and 11B are conceptual diagrams for explaining resource structures when a long PUCCH and a short PUCCH are multiplexed according to another embodiment of the present disclosure;

FIGS. 12A and 12B are conceptual diagrams for explaining resource structures when a long PUCCH and a short PUCCH are multiplexed according to yet another embodiment of the present disclosure;

FIGS. 13A and 13B are conceptual diagrams for explaining resource structures when a long PUCCH and a short PUCCH are multiplexed according to still yet another embodiment of the present disclosure;

FIG. 14 is a conceptual diagram for explaining a correspondence relationship between URLLC PDSCH mini-slots and short PUCCH symbols;

FIG. 15 is a conceptual diagram for explaining a situation in which transmission time points of PUCCHs including SRs having different priorities collide with each other;

FIGS. 16A and 16B are conceptual diagrams for explaining a processing method according to an embodiment of the present disclosure when a transmission interval of a PUCCH for SR1 and a transmission interval of a PUCCH for SR2 are collided;

FIG. 17 is a conceptual diagram for explaining a processing method according to another embodiment of the present disclosure when a transmission interval of a PUCCH for SR1 and a transmission interval of a PUCCH for SR2 are collided;

FIGS. 18A and 18B are conceptual diagrams for explaining a processing method according to yet another embodiment of the present disclosure when a transmission interval of a PUCCH for SR1 and a transmission interval of a PUCCH for SR2 are collided; and

FIG. 19 is a conceptual diagram for explaining a method of mapping UCIs having different latency requirements on PUCCH REs according to an embodiment of the present disclosure.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

Throughout the specification, a terminal may be a mobile terminal (MT), a mobile station (MS), an advanced mobile station (AMS), a high reliability mobile station (HR-MS), a subscriber station (SS), a portable subscriber station (PSS), an access terminal (AT), an user equipment (UE), or the like. Also, the terminal may include all or a part of functions of MS, AMS, HR-MS, SS, PSS, AT, UE, or the like.

Also, a base station may be an advanced base station (ABS), a high reliability base station (HR-BS), a node B, an evolved node B (eNB), an access point (AP), a radio access station (RAS), a base transceiver station (BTS), a mobile multi-hop relay (MMR)-BS, a relay station (RS), a high reliability relay station (HR-RS) or a small cell base station performing a role of the base station, or the like. Also, the base station may include all or a part of functions of ABS, HR-BS, node B, eNB, AP, RAS, BTS, MMR-BS, RS, HR-RS, small cell base station, or the like.

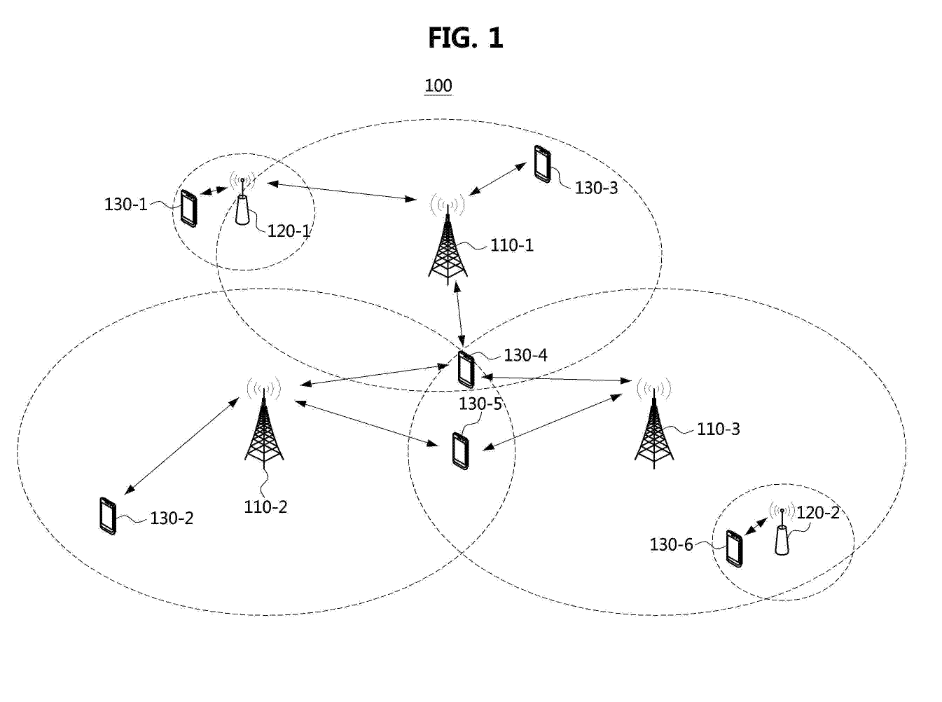

FIG. 1 is a conceptual diagram illustrating a mobile communication system according to a first embodiment of the present disclosure.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Each of the plurality of communication nodes may support at least one communication protocol. For example, each of the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, and a space division multiple access (SDMA) based communication protocol. Also, each of the plurality of communication nodes may have the following structure.

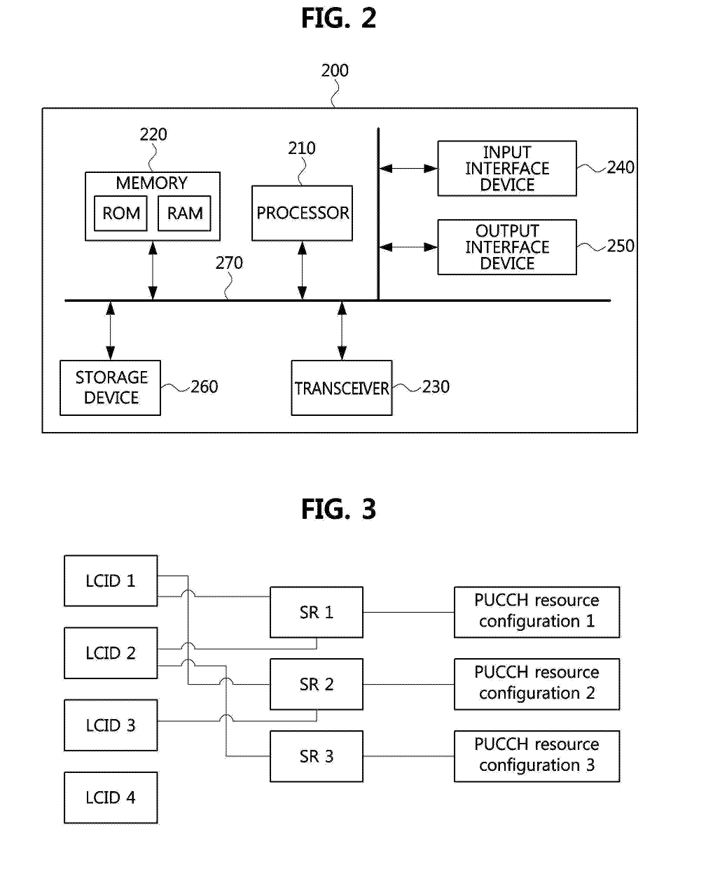

FIG. 2 is a block diagram illustrating a communication node in a mobile communication system according to a first embodiment of the present disclosure.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, even when a method (e.g., transmission or reception of a signal) to be performed in a first communication node among communication nodes is described, a corresponding second communication node may perform a method (e.g., reception or transmission of the signal) corresponding to the method performed in the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

The uplink control information (UCI) may refer to information other than data generated by a terminal (or, UE) and transmitted to a base station (e.g., a serving base station). For example, the UCI may include channel state information (CSI), hybrid automatic repeat request (HARQ) acknowledgement (ACK) or negative ACK (ACK/NACK) information, scheduling request (SR), or the like. Here, the CSI may be further subdivided into a channel quality indicator (CQI), a CSI-RS resource indicator (CRI), a precoding matrix indicator (PMI), a rank indicator (RI), and the like. Also, the PMI may be further subdivided into a first PMI and a second PMI.

First, a case where a UE transmits UCIs generated in one component carrier (CC) (or cell) or a bandwidth part (BWP) will be described.

The UE may transmit a part or all of the UCIs to a base station using PUCCH or physical uplink shared channel (PUSCH). In case that the UCIs are periodically transmitted, the UE may transmit the UCIs using the PUCCH. When the UE receives an uplink (UL) grant from the base station and a PUSCH resource is allocated, the UE may transmit the UCIs by utilizing a part of the allocated PUSCH resource.

Meanwhile, when a transmission power is sufficient, the UE may transmit the PUCCH and the PUSCH together in one slot. In this case, the UE may transmit a part or all of the UCIs on the PUCCH, and transmit the remaining UCIs using the PUSCH resource. On the other hand, when the transmission power is insufficient, the UE may map all the UCIs to resource elements (REs) of the PUSCH without transmitting the PUCCH.

Next, a case where a UE transmits UCIs generated in two or more CCs (or cells) or BWPs will be described.

Such the case may occur in a carrier aggregation (CA) environment in which two or more CCs are configured in one UE by a serving base station, or in an environment in which two or more BWPs are configured in one UE by a serving base station. As a similar case, a case in which two or more traffics are multiplexed and transmitted may exist. For example, when two data traffics are considered, the UE should transmit a UCI (i.e., UCI1) generated in the first traffic and a UCI (i.e., UCI2) generated in the second traffic to the serving base station. Similarly, when more than one CC is considered, the UE should transmit a UCI1 originated in the first CC and a UCI2 originated in the second CC to the serving base station.

If the UCI1 and the UCI2 can be transmitted in the same slot to the serving base station, the UE can transmit the UCI1 and the UCI2 in the same slot. However, if the UCI1 and the UCI2 cannot be transmitted in the same slot to the serving base station, the amount of the UCIs may be reduced by applying various methods, or if a UL grant is received, the UCIs may be transmitted as mapped to a part of resources of PUSCH. When the UCI is transmitted on the PUSCH, since a discrete Fourier transform (DFT) precoding is applied to the PUSCH, an effect of lowering peak-to-average power ratio (PAPR) can be obtained.

As a method of reducing the amount of UCIs, there is a method of applying a priority defined in the standard (e.g., only a UCI having a higher serving cell ID or a higher logical channel ID of traffic is transmitted, and another UCI is dropped), a method of applying compression to UCIs (e.g., a method of applying a logical AND operation), or the like. Through this, the amount of the entire UCIs may be reduced to an amount generated from one CC (or, BWP or data traffic). However, since the method of reducing the amount of UCIs results in performance deterioration (e.g., HARQ latency, CQI mismatch, etc.), it's desirable that the serving base station allocates more resources to maintain the amount of UCIs.

Hereinafter, as described above, an environment in which the UE transmits a UCI (hereinafter referred to as UCI1) generated in a first traffic (e.g., eMBB traffic) and a UCI (hereinafter referred to as UCI2) generated in a second traffic (e.g., URLLC traffic) to a serving base station in order to support two or more types of data traffics, and an environment in which the UE transmits a UCI (similarly, UCI1) generated in a first cell (e.g., PCell) and a UCI (similarly, UCI2) generated in a second ell (e.g., SCell) to the serving base station in order to support two or more serving cells may be assumed. In order to support such the environments, it is necessary to multiplex PUCCHs (e.g., long PUCCH and short PUCCH) having different lengths (different number of symbols).

Also, in the case of a communication system operating at a high frequency, the UE may transmit PUCCHs to the serving base station while changing a precoding applied to the PUCCHs (e.g., beam-sweeping operation). Therefore, the UE may apply a plurality of precoding schemes, so it is desirable to keep the number of symbols of one PUCCH small. As another scenario, a scenario, in which different types of UCIs are delivered per PUCCH, may be possible. The UE may generate a PUCCH including a CQI and a PUCCH including a HARQ-ACK as different PUCCHs, and transmit the generated PUCCHs to the serving base station. In this case, the PUCCH including the CQI may occupy a large number of symbols, but the PUCCH including the HARQ-ACK may occupy a small number of symbols.

As another example, each PUCCH may be configured to carry a UCI derived from a different usage scenario. The UE may transmit a HARQ-ACK for an NR eMBB (enhanced mobile broadband) PDSCH through the PUCCH having a large number of symbols, and a HARQ-ACK for a URLLC (ultra-reliable low-latency communication) PDSCH through the PUCCH having a small number of symbols. That is, the above-described scenarios may correspond to a case where one UE transmits two or more PUCCHs having different lengths in one slot. Hereinafter, a PUCCH occupying one or two symbols may be defined as a ‘short PUCCH’, and a PUCCH occupying four or more symbols may be defined as a ‘long PUCCH’.

A case where a first UE transmits a short PUCCH and a second UE transmits a long PUCCH in the same slot is considered. The serving base station of the first UE and the serving base station of the second UE may be different from each other, and may interfere with each other. Since the first UE can transmit the HARQ-ACK for the URLLC PDSCH on the short PUCCH, a position of the symbol(s) occupied by the short PUCCH may be arbitrarily located within a UL slot.

For example, in a frequency division duplex (FDD) system, if the serving base station transmits the URLLC PDSCH in a downlink (DL) slot, the first UE may receive the URLLC PDSCH and transmit a short PUCCH according to a HARQ-ACK timing indicated by a URLLC PDCCH. According to the HARQ-ACK timing, the UE may transmit the short PUCCH in arbitrary symbol(s) or a mini-slot belonging to a UL slot.

In another example, in a time division duplex (TDD) system, symbol(s) on which the UE transmits the short PUCCH for the URLLC PDSCH of the serving base station may belong to the same slot as the slot in which the URLLC PDSCH is received or a UL duration of the next slot. In the case that the time point of transmitting the HARQ-ACK for the URLLC PDSCH belongs to the same slot as the URLLC PDSCH, in order to secure a time required for the first UE to process the URLLC PDSCH, it may be preferable that the HARQ-ACK timing is signaled to the first UE so as to be located at the rear of the corresponding slot. On the other hand, in the case that the time point of transmitting the HARQ-ACK for the URLLC PDSCH belongs to the next slot, since the time required for the processing of the first UE is sufficient, it may be preferable that the HARQ-ACK timing is signaled to the first UE so as to be located at the beginning of the next slot.

Through this, the short PUCCH transmitted by the first UE can be multiplexed with the long PUCCH transmitted by the second UE in the same slot in the time division multiplexing (TDM) manner.

In a structure of a long PUCCH (e.g., NR PUCCH format 1) carrying a UCI of 1 or 2 bits, UCI bits are two-dimensionally spread by a spreading sequence and an orthogonal cover code (OCC), and mapped to REs of symbols. However, in order to support a dynamic TDD scenario, the number of symbols occupied by the long PUCCH may vary depending on the slot format. Meanwhile, a long PUCCH (e.g., NR PUCCH format 3 or 4) carrying UCI of 3 bits or more uses a waveform based on discrete Fourier transform spreaded OFDM (DFT-s-OFDM). Also, in a structure of a short PUCCH carrying a UCI of 1 or 2 bits, UCI bits are two-dimensionally spread by a spreading sequence and mapped to REs of one or two symbols. Also, a short PUCCH carrying UCI of 3 bits or more uses a waveform based on OFDM.

As described above, when the PUSCH and the UCI are to be transmitted together in the slot allocated by the UL grant, the UE may transmit the UCI together with the PUSCH by puncturing the PUSCH resource to which the PUSCH is mapped and mapping the UCI to the punctured resource, or by performing rate matching of the UCI with the PUSCH within the PUSCH resource. In this case, the serving base station may demodulate the UCI and the PUSCH using PUSCH demodulation reference signal (DM-RS). Meanwhile, in order to obtain a frequency multiplexing gain, the UCI may be evenly mapped to the frequency band allocated by the UL grant. In order to obtain a time multiplexing gain, the UCI may be evenly mapped in a UL slot or a UL mini-slot allocated by the UL grant. However, the UCI may also be mapped to only a part of the UL slot or UL mini-slot in order to reduce the number of punctured REs in a code block group (CBg) constituting the PUSCH. In such the case, it is difficult to obtain a time multiplexing gain.

Also, a case where the UE supports various types of UL traffics is considered. The serving base station may configure at least one scheduling request (SR) to be transmitted by the UE. The configuration for the at least one SR may include a cycle and a duration of a PUCCH through which a SR is transmitted, and may also define what type of UL data traffic corresponds to a specific physical resource. Here, the UL data traffics may be classified by logical channel IDs.

FIG. 3 is a conceptual diagram illustrating an example of a relationship between UL data traffics, physical resources, and scheduling requests.

Referring to FIG. 3, when a UL data traffic corresponding to a logical channel ID1 (i.e., LCID1) is generated in the UE, the UE may transmit SR1 or SR2. That is, the UE may select a PUCCH resource configuration 1 and a PUCCH resource configuration 2 to transmit the SR. Similarly, when a UL data traffic corresponding to a logical channel ID2 (i.e., LCID2) is generated in the UE, the UE may transmit SR1 or SR3. That is, the UE may select the PUCCH resource configuration 1 and a PUCCH resource configuration 3 to transmit the SR.

In FIG. 3, a logical channel ID4 (i.e., LCID4) does not define a correspondence with a SR. The UE may transmit a PUSCH using a resource periodically allocated from the serving base station without transmitting a SR when a UL data traffic corresponding to the LCID4 is generated. For example, the LCID4 may correspond to a UL voice-over-IP (VoIP) traffic or a grant-free PUSCH traffic using semi-persistent scheduling (UL SPS).

Methods of Transmitting Two or More PUCCHs in One Slot

The above-described situation in which two or more UCIs (UCI1 and UCI2) are to be transmitted may occur even when only one UE exists. For example, there may be a case where the UE needs to further transmit a UCI of a higher priority type while another PUCCH is already being transmitted. For example, there may be a case where a HARQ-ACK for a NR URLLC PDSCH is to be transmitted as UCI2 while a HARQ-ACK for a NR eMBB PDSCH is being transmitted as UCI1 over a long PUCCH. The failure to immediately transmit the UCI2 does not satisfy the low-latency requirement for the URLLC PDSCH. The above-described case may correspond to a case where the UE includes only the lower-ranked UCI (i.e., UCI1) in the long PUCCH when generating the long PUCCH, since the UE does not know the HARQ-ACK timing for the NR URLLC PDSCH in advance.

In order to solve the above-mentioned problems, at least three schemes may be considered in the present disclosure.

The first scheme is a method of transmitting the additional UCI2 by mapping the additional UCI2 to REs of the already-generated long PUCCH, the second scheme is a method of generating a separate short PUCCH using the additional UCI2 and transmitting the long PUCCH and the short PUCCH in the TDM manner, and the third scheme is a method of generating a separate short PUCCH using the additional UCI2 and transmitting the long PUCCH and the short PUCCH in a frequency division multiplexing (FDM) manner. Additionally, the puncturing may be considered in addition to these approaches.

For this, a processing capability of the UE may be considered. The UCI2 may be transmitted together with the UCI1 in one long PUCCH, or only the UCI1 may be transmitted through the long PUCCH and the UCI2 may be independently transmitted using a separate short PUCCH, according to a time point at which the UE can know the timing to transmit the UCI2. For example, the separate PUCCH may be generated for the UCI2 (e.g., HARQ-ACK) for the PDSCH occurring at least after a specific time point, and may be transmitted in the TDM or FDM manner.

Classification of UCI Processing Scheme According to Processing Capability of UE

As described above, the long PUCCH may be assumed to be transmitted by spreading the UCI in the time domain or by performing a channel cording and mapping to REs. Hereinafter, for convenience of explanation, it is assumed that the UE transmits the UCI1 using a first PUCCH (hereinafter referred to as ‘PUCCH1’) and transmits the UCI2 using a second PUCCH (hereinafter referred to as ‘PUCCH2’). Here, the PUCCH1 may be a long PUCCH and the PUCCH2 may be a short PUCCH.

Tⱼ may be defined as a time required for the UE to perform mapping of the encoded UCIⱼ to the PUCCHⱼ (j-1, 2). The units of Tⱼ may correspond to symbols or slots. The UE may provide information on its processing capability to the serving base station.

Accordingly, the serving base station may estimate the time T₂ for the UE to generate the UCI2 for the URLLC PDSCH transmitted to the UE. The UCI2 may be a URLLC DL CSI by a CSI trigger or a HARQ-ACK for the URLLC PDSCH. The value of T may be affected by the size of a transport block (TB), a code rate, and a CSI reporting mode.

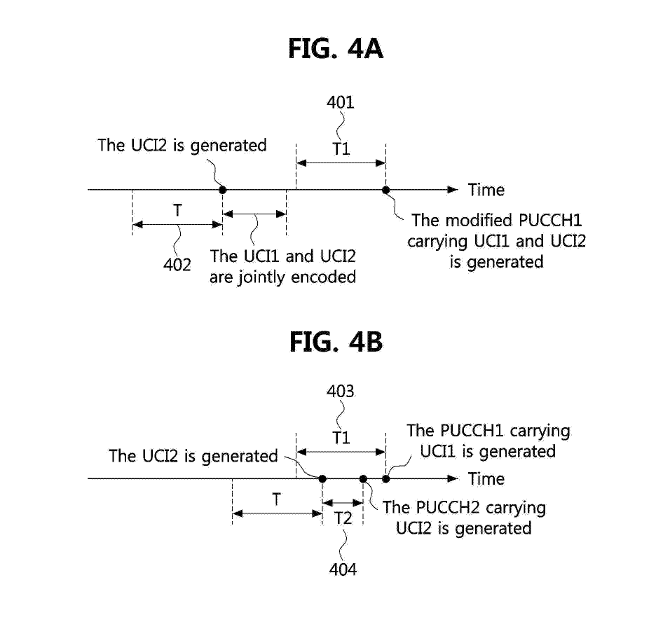

FIGS. 4A and 4B are conceptual diagrams for explaining a processing method of UCI2 according to a generation time point of UCI2.

Referring to FIG. 4A, since the UCI2 has already been generated at a time point before a PUCCH1 generation period 401, the UE may jointly encode the UCI1 and the UCI2 to transmit the UCI1 and the UCI2 through one PUCCH (i.e., PUCCH1). At this time, the UE may apply repetition, spreading, simplex coding, Reed-Muller coding or Polar coding as defined in the standard. Coding chains applied to the UCI1 and the UCI2 may be different from each other, so that code rates and resource mapping for the UCI1 and the UCI2 may be different from each other.

Referring to FIG. 4B, since the UCI2 is generated at a time point in a PUCCH1 generation period 403 during which the PUCCH1 is being generated, there is insufficient time to jointly encode the UCI2 with the UCI1 before transmitting the PUCCH1. Therefore, the UE may generate the PUCCH2 for transmitting the UCI2 separately from the PUCCH1 during a PUCCH2 generation period 404. In this case, the UE may consider a scheme of multiplexing the PUCCH2 and the PUCCH1 in the TDM manner or the FDM manner or a scheme of transmitting the PUCCH2 by puncturing resources (i.e., REs) of the PUCCH1.

TDM Transmission of PUCCHs

The UE may transmit the UC1 on the PUCCH1 which is a long PUCCH, and the UCI2 on the PUCCH2 which is a short PUCCH, in the TDM manner. The UE may transmit the PUCCHs based on timings indicated by radio resource control (RRC) signaling and downlink control information (DCI) from the serving base station. Here, the PUCCH1 which is a long PUCCH can carry not only 1 or 2 UCI bits but also several hundreds of UCI bits, and the PUCCH2 which is a short PUCCH can carry not only 1 or 2 UCI bits but also several tens of UCI bits. The TDM transmission of PUCCHs may be classified into several cases depending on relative positions of the PUCCHs.

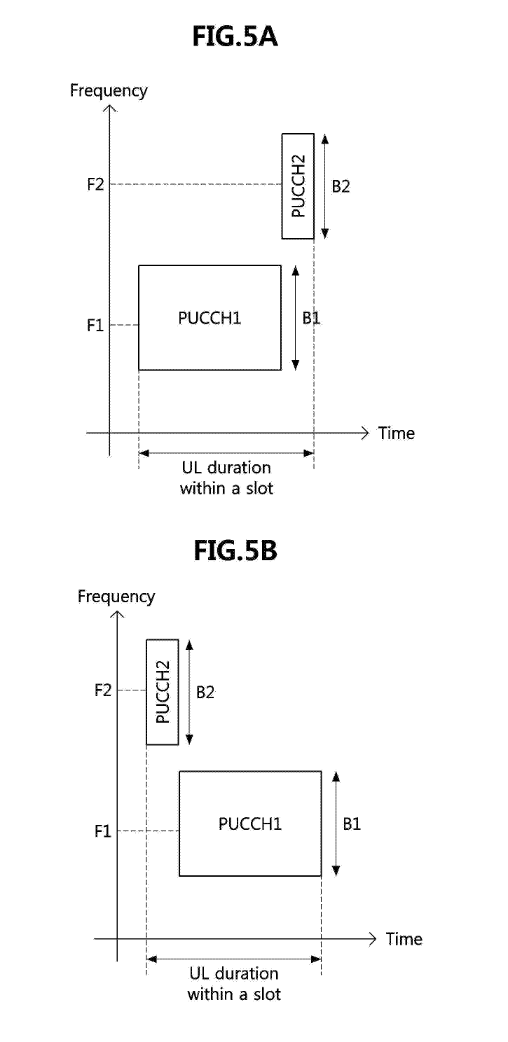

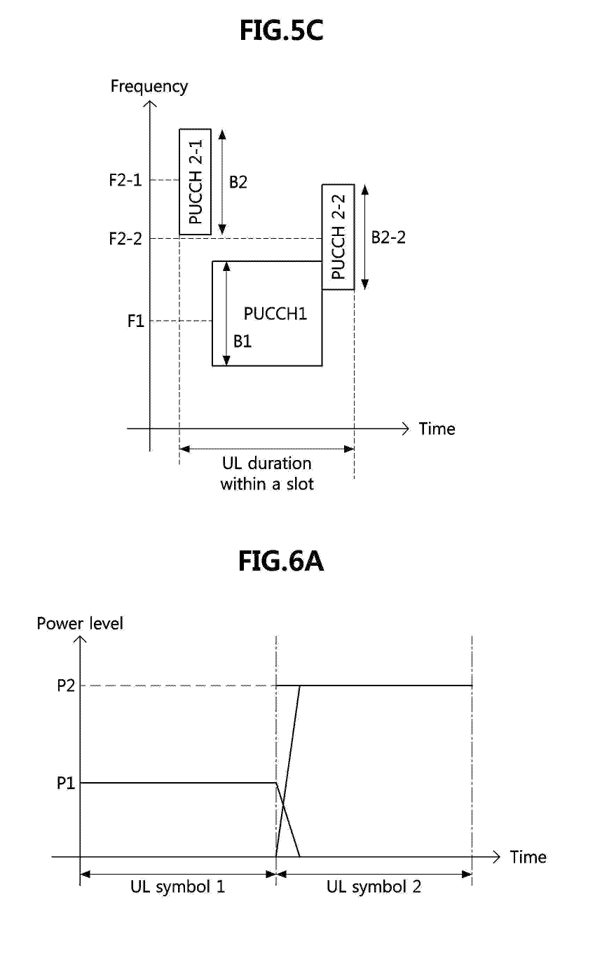

FIGS. 5A to 5C are conceptual diagrams for explaining cases of multiplexing and transmitting PUCCHs in a TDM manner.

In FIGS. 5A to 5C, the center frequencies of PUCCH1 and PUCCH2 are respectively designated as F1 and F2, and the bandwidths of PUCCH1 and PUCCH2 are respectively defined as B1 and B2.

Referring to FIGS. 5A and 5B, the PUCCH2 is always located at both ends of the PUCCH1, and the PUCCH2 may be transmitted later than the PUCCH1 (in FIG. 5A) or the PUCCH2 may be transmitted earlier than the PUCCH1 (in FIG. 5B). The PUCCH1 and the PUCCH2 may use different frequency bands (i.e., F1≠F2) and may have different bandwidths (i.e., B1≠B2).

The cases illustrated in FIGS. 5A and 5B may be cases where the serving base station instructs the HARQ-ACK timing so that the UE transmits the short PUCCH (i.e., PUCCH2) only at both ends of the slot in consideration of the HARQ-ACK timing for the URLLC PDSCH received in a DL mini-slot.

That is, assuming that the UE receives the URLLC PDCCH in a front part of a DL slot, the case illustrated in FIG. 5A may be an example of the HARQ-ACK timing for a self-contained operation. That is, the HARQ-ACK for the URLLC PDSCH may be located at a rear part of the slot in which the URLLC PDSCH is received, so that the long PUCCH and the short PUCCH are multiplexed in the TDM manner. On the other hand, the case illustrated in FIG. 5B may be a case where the HARQ-ACK timing for the URLLC PDSCH is adjusted according to the capability of the UE. That is, the HARQ-ACK timing for the URLLC PDSCH is located in a front part of the next slot of the slot in which the URLLC PDSCH is received, so that the long PUCCH and the short PUCCH are multiplexed in the TDM manner.

Also, the case illustrated in FIG. 5C may correspond to a case in which all of the cases illustrated in FIGS. 5A and 5B occur in one slot.

In case that a frequency hopping is applied, a PUCCH may maintain the same frequency resource for a predetermined time interval, but may use another frequency resource for a time interval thereafter. Also, when the PUCCH1 and the PUCCH2 use different frequency resources, the serving base station should estimate a UL channel, so the UE should transmit a DM-RS separately. Therefore, when performing TDM between the PUCCHs, such the DM-RS overhead should be considered. In this case, it is desirable that the PUCCH2 utilizes the frequency resources used by the PUCCH1 (i.e., F1=F2).

In order to configure F1 and F2 to be the same, the frequency resource for transmitting the PUCCH1 may be shifted to F2, the frequency resource for transmitting the PUCCH2 may be shifted to F1, or the PUCCH1 and PUCCH2 may be transmitted at a third frequency F3. However, since the PUCCH1, which is a long PUCCH, can carry hundreds of UCI bits, the time required to generate a long PUCCH and perform resource mapping may be longer than the time required for a short PUCCH. In this reason, it is preferable that the PUCCH1 which is a long PUCCH maintains the frequency resource F1. Therefore, it is preferable that the frequency resource F2 of the PUCCH2 which is a short PUCCH is shifted to F1 while maintaining the frequency resource F1 of the PUCCH1 which is a long PUCCH.

If the UE separately transmits a DM-RS for the PUCCH1 and a DM-RS for the PUCCH2, the serving base station may use both of the DM-RS for the PUCCH1 and the DM-RS for the PUCCH2 to estimate a higher quality UL CSI. Since the UE can apply the same DM-RS structure irrespective of the presence of the PUCCH1 or the PUCCH2, the implementation may become simple, and detection of discontinuous transmission (DTx) may also become even easier in the serving base station.

In case that the PUCCH1, that is a long PUCCH, and the PUCCH2, that is a short PUCCH, have different bandwidths (i.e., B1≠B2), since the DM-RS for the PUCCH2 is transmitted separately, the number of symbols or REs to transmit the UCI bits may decrease. Accordingly, it is preferable that the bandwidth of the PUCCH2 is matched to the bandwidth of the PUCCH1 (i.e., B1=B2).

Transmission Power Control Method for PUCCHs Transmitted in TDM Manner

It may be desirable to apply the same transmission power to the PUCCH1 which is a long PUCCH and the PUCCH2 which is a short PUCCH. However, when the serving base station independently configures transmission powers to the PUCCH1 and the PUCCH2, the PUCCH1 and the PUCCH2 may have different transmission power. Since the PUCCH1 and the PUCCH2 may have different waveforms or formats, the serving base station may use a waveform-dependent offset or a format-dependent offset to configure transmit power control (TPC) commands. Therefore, a transmission power P1 according to a power control process for the PUCCH1 and a transmission power P2 according to a power control process for the PUCCH2 may be different from each other. That is, P1≠P2. In this case, the UE does not meet a power level required by either of symbols at the boundary between the symbols constituting the PUCCH1 and the symbols constituting the PUCCH2. Therefore, there may be a transient time in which the transmission power changes from P1 to P2 in two UL symbols forming the boundary between the PUCCH1 and the PUCCH2.

Meanwhile, considering a case where the PUCCH1 which is a long PUCCH is transmitted from a first UE UE1 and the PUCCH2 which is a short PUCCH is transmitted from a second UE UE2, the PUCCH1 and the PUCCH2 may cause interference in the serving base station during the transient time between the PUCCH1 and the PUCCH2. Since both the PUCCH1 and the PUCCH2 contain UCIs, a probability of error occurrence should be kept as low as possible. Therefore, it may be possible to consider a method of allocating a transient gap necessary for the UE to switch the transmission power of the PUCCH. This transient gap may be included in a symbol duration or may be included outside a symbol duration.

1) A Case that a Transient Gap for Switching of PUCCH Transmission Power Exists within a Symbol Duration

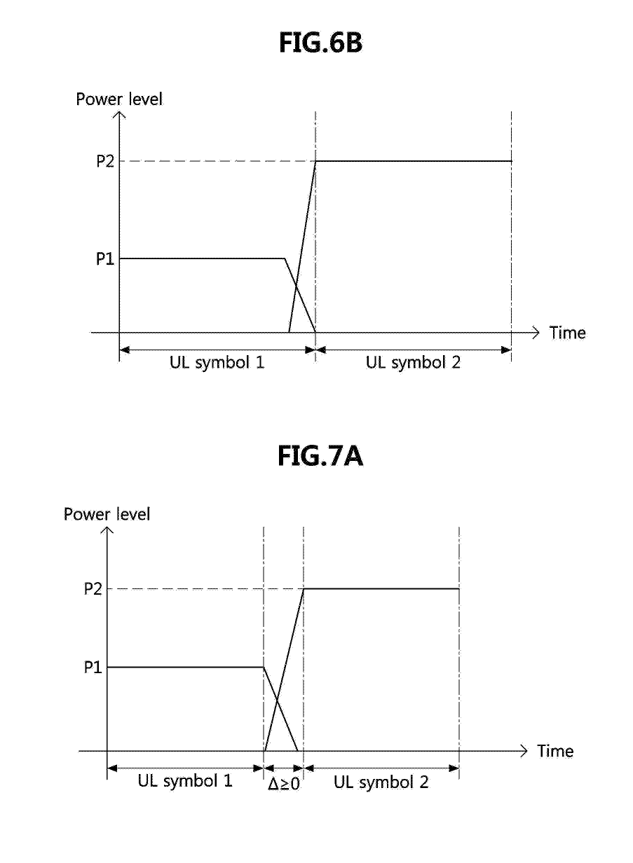

FIGS. 6A and 6B are conceptual diagrams for explaining cases in which a transient gap at the boundary of PUCCHs exists within a symbol duration.

Specifically, FIG. 6A illustrates a case that a priority is given to a first UL symbol (i.e., the last symbol of the PUCCH1) among two UL symbols forming the boundary, and FIG. 6B illustrates a case that a priority is given to a second UL symbol (i.e., the first symbol of the PUCCH2) among the two UL symbols forming the boundary. For example, the UE may be implemented to preferentially satisfy a transmission power of a more significant UL symbol. In this case, the error probability may be somewhat increased in the UCI transmitted in a relatively less significant UL symbol.

In general, it may be seen that the symbols constituting the long PUCCH (e.g., PUCCH1) are relatively less important. In the case that the UCI1 for the eMBB PDSCH is composed of 1 or 2 bits, even if the transmission power during the transient gap in the last symbol or the first symbol of the long PUCCH including symbols composed of spreading sequences does not satisfy the requirement, the error probability of UCI1 may not have a great influence. Also, in the case that the UCI1 for the eMBB PDSCH is composed of more than 3 bits, error correction can be performed because channel coding (e.g., linear block coding) has been applied to the UCI1. Therefore, even if the transmission power does not satisfy the requirement during the transient gap in the last symbol or the first symbol constituting the long PUCCH PUCCH1, the error probability of UCI1 may not be greatly affected.

Therefore, when the PUCCH2 and the PUCCH1 are transmitted in the TDM manner in the order of the PUCCH2 and the PUCCH1, the first UL symbol (i.e., the last symbol of the PUCCH2) of the two symbols forming the boundary may be preferably prioritized. On the other hand, when the PUCCH2 and the PUCCH1 are transmitted in the TDM manner in the order of the PUCCH1 and the PUCCH2, the second UL symbol (i.e., the first symbol of the PUCCH2) of the two symbols constituting the boundary may be preferably prioritized.

Following this priority, power limit requirements for the PUCCH1, which is a long PUCCH, may be defined in the standard. For example, with respect to the first or last symbol of the PUCCH1, which is a long PUCCH, power requirements when adjacent to and not adjacent to a symbol of short PUCCH may be specified differently. The requirements of the standard may correspond to ‘ON/OFF mask’ and ‘ON power requirement’.

Meanwhile, in the LTE based system, a sounding reference signal (SRS) is located in a last symbol of a slot, and a shortened PUCCH and a shortened PUSCH may be located in a subframe region excluding the last symbol of the slot. However, the SRS of the LTE based system plays a role of timing advance management and UL CSI measurement, and has a lower priority than UCI or uplink data. Therefore, during the transient gap, a symbol of the SRS may receive interference from other UEs, and the serving base station may be implemented to remove the interference.

2) A Case that a Transient Gap for Switching of PUCCH Transmission Power Exists Outside a Symbol Duration

This case may be considered when some resources of the symbols constituting the slot are empty. That is, this case may be applied to a slot format including a UL duration, a guard period, and a DL duration in one slot. That is, since the gap occupies a part of the guard period, it may reduce a maximum propagation delay supported by the serving base station.

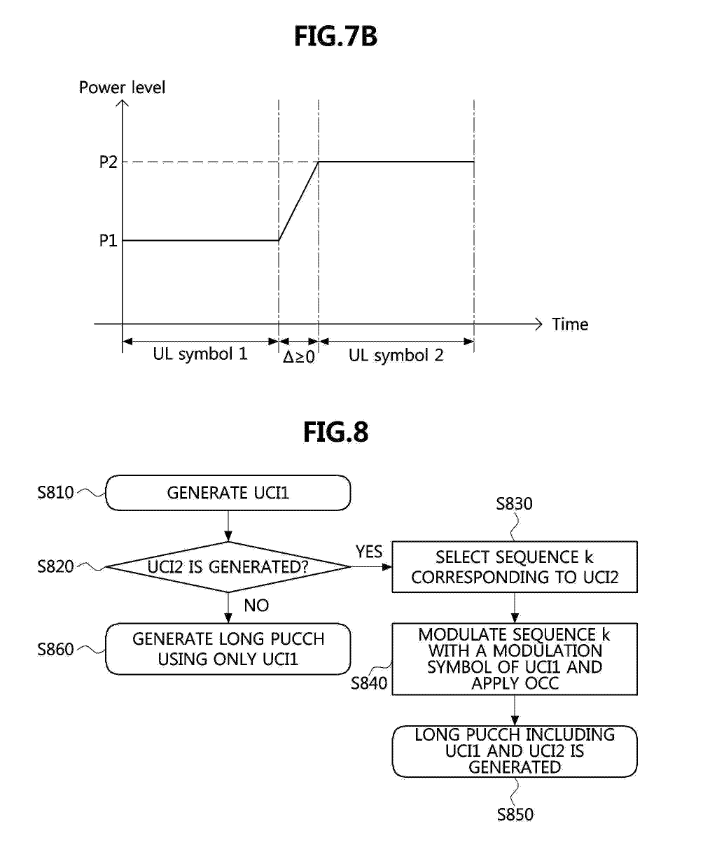

FIGS. 7A and 7B are conceptual diagrams for explaining cases in which a transient time at the boundary of PUCCHs exists outside a symbol duration.

Referring to FIGS. 7A and 7B, a transient gap (Δ≥0) between two symbols forming a boundary is introduced to secure the time for the UE to switch the transmission power. For example, ‘ON/OFF mask’ and ‘ON power requirement’ may be defined in the standard so that the UE does not transmit UCI within the transient gap. For example, this transient gap may require a long time (˜10 s Ts) or a short time (˜1 s Ts) depending on the capability of the UE. The serving base station may introduce the transient gap within the slot in consideration of the time length of the gap required for the UEs.

The transient gap may be defined as a constant offset or may be signaled from the serving base station to the UE. For example, if a short PUCCH and a long PUCCH coexist, the serving base station may instruct the UE to apply a constant offset from a timing advance command of the short PUCCH. Here, the constant offset may follow the standard defined value. In another example, the serving base station may transmit a cell-specific offset to the UE in consideration of the capability of the UE. The serving base station may maintain orthogonality of the PUCCHs transmitted by the UEs using the cell-specific offset or the constant offset.

Since the PUCCH2 that is a Short PUCCH may include a HARQ-ACK for a URLLC PDSCH, it may be preferable to change the timing of the PUCCH1, that is a long PUCCH, by a predetermined amount (Δ≥0), instead of changing the timing for the PUCCH2. If the PUCCH2, which is a short PUCCH, is transmitted at an earlier time point, it may be necessary to reduce a decoding time of the URLLC PDSCH. Also, if the PUCCH2 is transmitted at a later time point, a time required to receive the HARQ-ACK may increase.

Therefore, it is preferable that the serving base station adjusts the timing advance applied to the long PUCCH by the offset Δ in the slot in which the long PUCCH and the short PUCCH are transmitted in the TDM manner. For example, if the PUCCH2, which is a short PUCCH, is located at the end of a slot as shown in FIG. 5A, the PUCCH1, which is a long PUCCH, may be transmitted earlier by the offset Δ. On the other hand, if the PUCCH2, which is a short PUCCH, is located at the front of a slot as shown in FIG. 5B, the PUCCH1, which is a long PUCCH, may be transmitted later by the offset Δ.

Methods of Multiplexing Short PUCCH with Long PUCCH

In general, if a UE needs to transmit UCI2 after generating a PUCCH1 that is a long PUCCH, the UE may consider transmission through puncturing on the long PUCCH. That is, a symbol constituting the PUCCH2 which is a short PUCCH may be transmitted at some symbol positions of the long PUCCH, rather than a symbol of the long PUCCH. The short PUCCH symbol may be generally configured by the serving base station to use a PRB different from that of the long PUCCH. However, in case of puncturing the long PUCCH to transmit UCI2, it is more effective for channel estimation and radio frequency (RF) parts of the UE that the short PUCCH also uses the PRB used by the long PUCCH. This may allow the base station to more accurately detect the short PUCCH including UCI2 using the long PUCCH DM-RS. Also, since the UE uses a narrower bandwidth without performing frequency hopping, the UE does not need to retune the RF parts of the UE.

Meanwhile, the present disclosure proposes a method of transmitting a long PUCCH and a short PUCCH together without using the puncturing described above.

A Case that UCI1 of PUCCH1 is Composed of 1 or 2 Bits

In the case that the UCI1 is composed of 1 bit, the PUCCH1, which is a long PUCCH, may be generated by modulating a spreading sequence using a binary phase shift keying (BPSK) symbol. Also, in the case that the UCI1 is composed of 2 bits, the PUCCH1, which is a long PUCCH, may be generated by modulating a spreading sequence using a quadrature phase shift keying (QPSK) symbol. In the PUCCH1 which is a long PUCCH, DM-RS sequences and the modulated spreading sequences may be alternately mapped to REs of OFDM symbols. Then, OCCs between the DM-RS symbols and OCCs between the spreading sequence symbols may be applied.

Meanwhile, in the case that the PUCCH2, which is a short PUCCH, is composed of 1 or 2 bits, the 1 or 2 bits may be expressed by selecting one of sequences defined in the standard. The sequences defined in the standard may be represented by two types (when the UCI2 is composed of 1 bit) or four types (when the UCI2 is composed of 2 bits), one sequence belonging to the same base sequence group is selected, a cyclic shift is applied differently according to the information of the UCI2, and a final sequence is determined.

FIG. 8 is a flowchart illustrating a method of multiplexing and transmitting a short PUCCH in a long PUCCH at a UE according to an embodiment of the present disclosure.

Referring to FIG. 8, the UCI1 to be transmitted through the PUCCH1 may be generated first (S810). Then, the UE may determine whether the UCI2 has been generated before transmission of the UCI1 (S820), and when the UCI2 is determined to have been generated, the UE may select a sequence k (k=1,2 or 1,2,3,4) corresponding to the UCI2 (S830). On the other hand, when it is determined in the step S820 that the UCI2 has not yet been generated, the UE may generate the PUCCH1 using only the UCI1 (S860).

The sequence k for encoding the UCI2 may be represented as rₖ ∈ C^{B×1}, and the QPSK modulation symbol corresponding to the UCI1 may be represented as q ∈ C. Then, the UE may allocate rₖ·q·o ∈ C^{B×1} to a symbol of the PUCCH (S840). Accordingly, a PUCCH, which is a long PUCCH including both the UCI1 and the UCI2, may be generated (S850).

Here, B denotes the number of sub-carriers which the PUCCH1 has, and o denotes an OCC value. In the case that only the UCI1 is transmitted without the UCI2, o may have the same value as an OCC value applied to the PUCCH symbol. If the long PUCCH uses 1 PRB, the value of B may be 12.

The embodiment of the present disclosure described above is characterized in that a modulation of a spreading sequence for transmitting the UCI1 and a sequence selection for transmitting the UCI2 are applied together. That is, the sequence selected according to the UCI2 is modulated using a modulation symbol (QPSK or BPSK symbol) according to the UCI1.

The sequence selected and modulated through the above-described procedure may be mapped to REs of an OFDM symbol. Here, a position (i.e., an index) of the OFDM symbol to which the sequence is mapped may be determined by the timing at which the UCI2 should be transmitted. That is, the generated OFDM symbol including both the UCI1 and the UCI2 may be transmitted at the OFDM symbol position corresponding to the timing to transmit the UCI2 instead of the OFDM symbol including only the UCI1. Therefore, in the embodiment of the present disclosure, the UCI2 can be transmitted without additional latency.

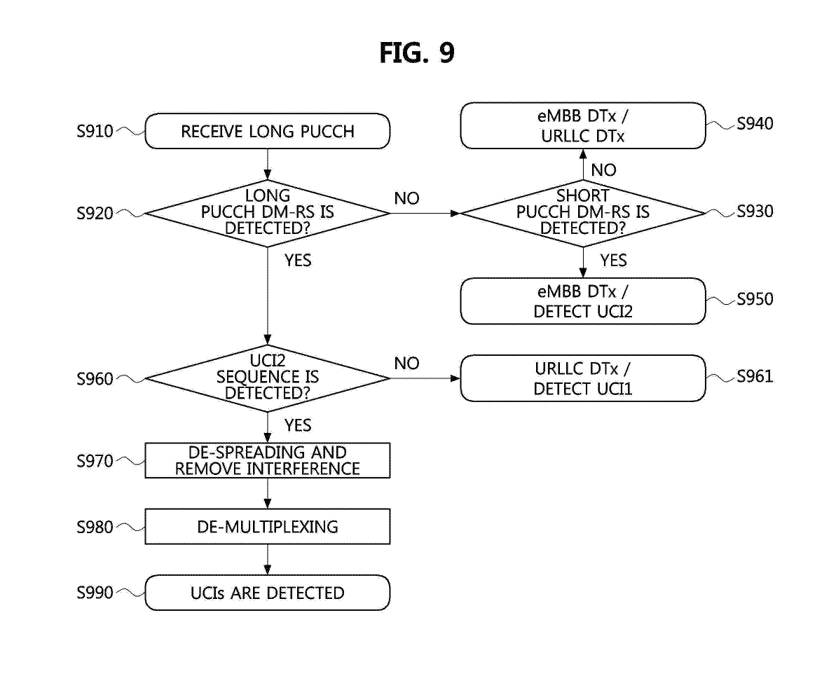

FIG. 9 is a flowchart illustrating a method of receiving a long PUCCH in which a short PUCCH is multiplexed at a base station according to an embodiment of the present disclosure.

Referring to FIG. 9, the base station may receive a signal comprising the PUCCH generated in the step S850 described referring to FIG. 8 (S910). That is, the PUCCH received by the base station in the step S910 may be the long PUCCH including both the UCI1 and the UCI2 generated according to the method described with reference to FIG. 8.

The base station may attempt to detect a long PUCCH DM-RS from the received signal (S920), and if the long PUCCH DM-RS is not detected, the base station may attempt to detect a short PUCCH DM-RS from the received signal (S930). If a short PUCCH DM-RS is not detected in the step S930, the base station may determine that the UE is in an eMBB DTx state and a URLLC DTx state (S940). On the other hand, if a short PUCCH DM-RS is detected in the step S930, the base station may determine that the UE is in the eMBB DTx state, and perform detection of the UCI2 (S950).

On the other hand, if a long PUCCH DM-RS is detected in the step S920, the base station may first detect the sequence for the UCI2 (i.e., rₖ ∈ C^{B×1}) from the received signal (i.e., y ∈ C^{B×1}) (S960). At this time, if the sequence for the UCI2 is not detected, the base station may determine that the UE is in the URLLC DTx state, and perform detection of UCI1 (S961).

For example, the base station may coherently detect the spreading sequence applied to the received signal y to determine whether the UCI2 transmitted by the UE is present or not in the received signal y, and may detect the value of the UCI2 if the UE is not in the DTx state. Here, the error rate of the UCI2 obtained by the UE is equal to the error rate when the UCI2 is transmitted alone using a short PUCCH. This is because, in the embodiment of the present disclosure, the UCI2 is transmitted as mapped to REs of the long PUCCH by using the structure of the short PUCCH as it is.

Meanwhile, if the sequence of the UCI2 is detected in the step S960, the received signal may be despreaded to remove interference (S970), and the UCH may be de-multiplexed by using the OCC (o) applied to the UCI1 (S980). Finally, the UCI1 and the UCI2 are detected together (S990).

Hereinafter, a resource structure of the long PUCCH generated according to the length (1 symbol or 2 symbols) of the short PUCCH multiplexed on the long PUCCH will be described.

(A) 1 Symbol Case

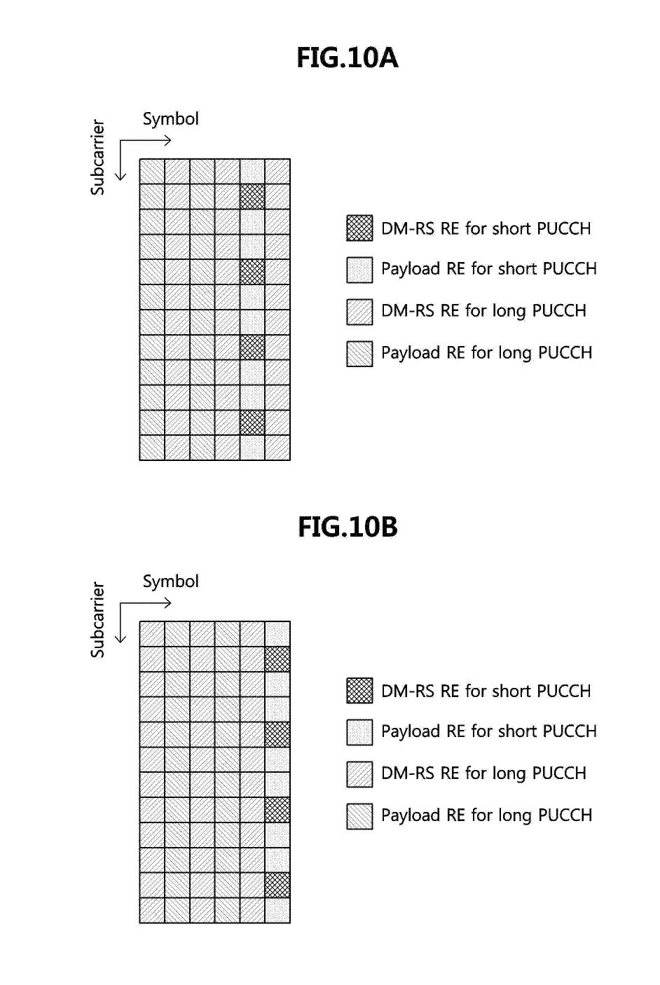

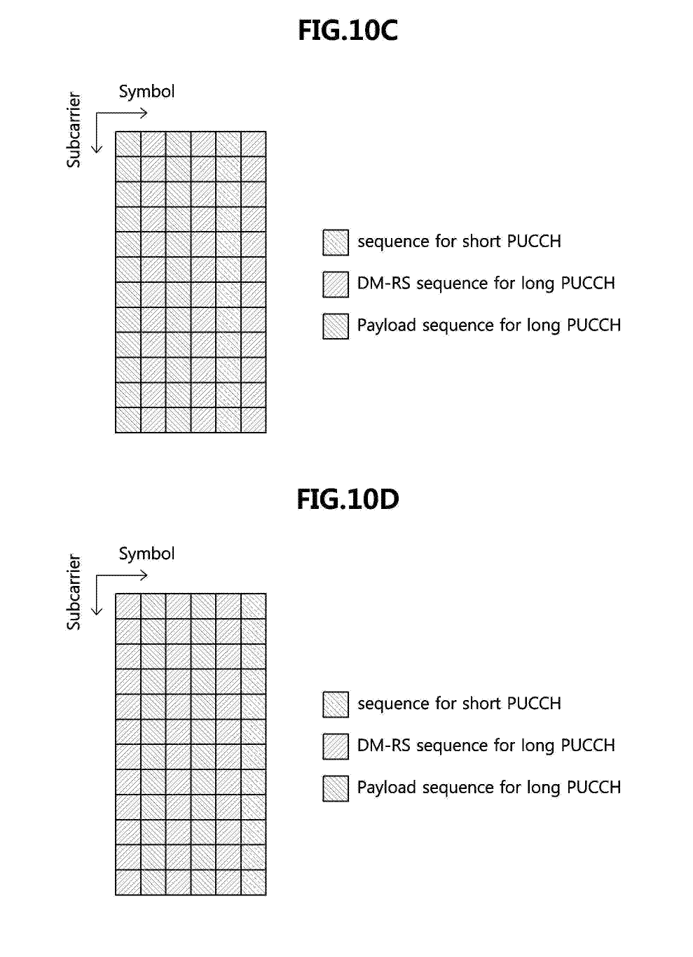

FIGS. 10A to 10D are conceptual diagrams for explaining resource structures when a long PUCCH and a short PUCCH are multiplexed according to an embodiment of the present disclosure.

FIGS. 10A and 10B illustrate resource structures of the PUCCH generated through the method described in FIG. 8 (i.e., the case when a frequency hopping is not applied). The resource structures of FIGS. 10A and 10B are based on the structure of the long PUCCH and the short PUCCH defined in the 3GPP NR standardization.

As described above, in the 3GPP NR-based mobile communication system, the long PUCCH may including DM-RS symbols and UCI payload symbols alternately, and resource mapping may vary according to the length of the UL slot and whether the frequency hopping is enable or disabled. FIG. 10A shows a case where a UCI payload symbol is located first, and FIG. 10B shows a case where a DM-RS symbol is located first.

Meanwhile, the short PUCCH may be configured by selecting one of the sequences according to a value of a UCI to be transmitted. The UE may combine values received via the RRC signaling and the DCI from the serving base station to select one base sequence group and apply a cyclic shift to the selected base sequence according to the value of the UCI to be transmitted to determine the sequence for the short PUCCH.

FIG. 10A illustrates a case where the HARQ-ACK timing, at which the UE transmits the UCI2 which is an ACK/NACK information for a URLLC PDSCH, is assumed to be the last second symbol among the resources of the long PUCCH. Also, FIG. 10B illustrates a case where the HARQ-ACK timing, at which the UE transmits the UCI2 which is an ACK/NACK information for a URLLC PDSCH, is assumed to be the last symbol among the resources of the long PUCCH. The HARQ-ACK timing may be adjusted using DCI and RRC signaling at the serving base station.

Meanwhile, in FIGS. 10A and 10B, sequences for the DM-RS and the UCI payload indicating the contents of the actual UCI2 are configured separately. However, one sequence may be configured to perform roles of both the DM-RS and the payload. That is, in case that the UCI2 is composed of 1 or 2 bits, one sequence may be used without distinguishing between DM-RS and UCI payload. However, in case that the UCI2 is composed of 3 bits or more, the DM-RS and the UCI payload should use different sequences.

FIGS. 10C and 10D illustrate cases in which one sequence performs the roles of both the DM-RS and the UCI payload. The resource structure of FIG. 10C may correspond to that of FIG. 10A, and the resource structure of FIG. 10D may correspond to that of FIG. 10B.

Even using the resource structures illustrated in FIGS. 10A to 10D, since the number of QPSK symbols modulated according to the UCI1 is maintained to be equal to the number of QPSK symbols of conventional long PUCCH through which only UCI1 is transmitted, and the amount of DM-RS is further increased (i.e., the DM-RS of the multiplexed short PUCCH is additionally available), the error rate of the UCI1 can be maintained regardless of the presence of the UCI2.

(B) 2 Symbol Case

Meanwhile, the UE may transmit a short PUCCH (i.e., PUCCH2) including the UCI2 using two symbols. In this case, it may affect both the DM-RS symbol and the UCI payload symbol of the long PUCCH. This is because, as mentioned above, in the long PUCCH, the DM-RS symbol and the UCI symbol are alternately present.

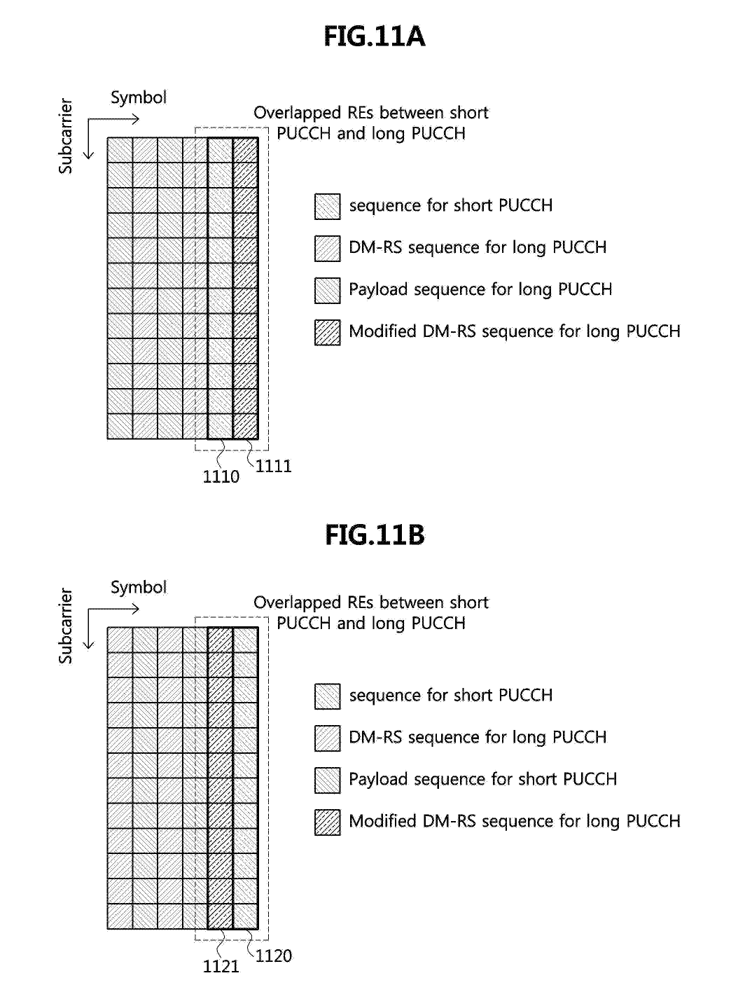

FIGS. 11A and 11B are conceptual diagrams for explaining resource structures when a long PUCCH and a short PUCCH are multiplexed according to another embodiment of the present disclosure.

FIG. 11A shows a case where a UCI payload symbol is located first, and FIG. 11B shows a case where a DM-RS symbol is located first.

Referring to FIGS. 11A and 11B, similarly to the above-described method, the sequence used in the short PUCCH may be mapped to UCI payload symbols 1110 and 1120 (the fifth symbol position in FIG. 11A and the last symbol position in FIG. 11B) instead of the sequence used for the long PUCCH. Meanwhile, for DM-RS symbols 1111 and 1121 (the last symbol position in FIG. 11A and the fifth symbol position in FIG. 11B), a method (hereinafter, method (a)) of using the DM-RS sequence used by the long PUCCH as it is, or a method (hereinafter, method (b)) of using the DM-RS sequence used by the long PUCCH as modified may be considered.

In the method (a), when performing channel estimation for the UCI1 at the serving base station, the estimated quality can be kept to be the same regardless of the presence of the UCI2. However, since only one symbol is allocated for the short PUCCH, not the two symbols, the reception quality of the UCI2 may be lowered.

In the method (b), the detection hypothesis necessary for the serving base station to receive the DM-RS may increase. Since the serving base station cannot know in advance whether the UE will transmit the UCI2 or not, if the DM-RS sequence is modified, the serving base station may know information about whether the UE transmits the UCI2.

As one of methods of changing the DM-RS sequence, the UE may change a cyclic shift (α) of the DM-RS sequence according to the value of the UCI2. For example, when 2 bits are transmitted as the UCI2, δ which is one of {0, 3, 6, 9} (i.e., δ ∈ {0, 3, 6, 9}) may be added to the predetermined cyclic shift value (α) of the DM-RS sequence. That is, (α+δ) may be applied as a cyclic shift value. Here, the value δ corresponding to 2 bits is expressed as 0, 3, 6, or 9 by dividing the cyclic shift at equal intervals. For example, when 1 bit is transmitted as the UCI2, δ which is one of {0,6} may be added to the predetermined cyclic shift (α) of the DM-RS sequence. That is, (α+δ) may be applied as a cyclic shift value. In this case, the cyclic shift value δ may be equally added to the predetermined cyclic shift value of the sequence for the DM-RS symbol of the long PUCCH, as well as to the predetermined cyclic shift value of the UCI symbol sequence of the long PUCCH. Then, the UE may generate the changed UCI sequence and the changed DM-RS sequence by applying the changed cyclic shift. For a UCI sequence r that reflects or does not reflect the UCI2, the UE may perform sequence modulation with a complex value q representing the value of UCI1 to obtain q·r. Then, the OCC may be applied regardless of presence of the UCI2.

Meanwhile, as another embodiment of the present disclosure, when configuring the long PUCCH for the UCI1, sequence selection may be applied instead of sequence modulation by using the value of UCI1. That is, a method similar to the sequence selection using the UCI2 value may be applied to the UCI1. In this case, since the long PUCCH through which the UCI1 is transmitted and the short PUCCH that constitutes the UCI2 have the same channel structure, the transmission method described in FIG. 8 and the reception method described in FIG. 9 may not be directly applied. However, since the sequence selection is applied to both the UCI1 and the UCI2 in the UE, both the UCI1 and the UCI2 can be transmitted in the same slot.

In order to apply this method, a sequence group index applied to the long PUCCH and a sequence group index applied to the short PUCCH may be applied differently. The cross-correlation is low among sequences belonging to different sequence groups, and the auto-correlation is low among sequences to which other cyclic shifts are applied while belonging to the same sequence group.

Specifically, as a method of generating a sequence corresponding to the UCI1 transmitted through a long PUCCH, the serving base station may indicate a sequence belonging to one sequence group to the UE via RRC signaling, and the UE may generate a sequence applied to the long PUCCH by applying a different cyclic shift according to the UCI1. Also, the sequence corresponding to the UCI2 transmitted on the short PUCCH may be generated in the same manner. Here, in order for the serving base station to simultaneously detect the UCI1 and the UCI2, the serving base station may specify the sequence group index applied to the long PUCCH and the sequence group index applied to the short PUCCH differently.

For example, when the UCI1 is composed of x bits and the UCI2 is composed of y bits, the UE may divide available cyclic shifts in the sequence designated by the sequence group index for the long PUCCH (e.g., if the sequence length is 12, the number of the available cyclic shifts may be 12) into 2^{x} cyclic shifts at equal intervals to represent the UCI1. The UE may select a sequence group index corresponding to the value of the UCI2 from 2^{y} possible sequence group indices. Accordingly, the serving base station may examine 2^{x+y} sequences to detect the UCI1 and the UCI2 transmitted by the UE.

The sequence groups configured by the serving base station to the UE may be generally configured in a cell-specific manner based on a UL cell planning. However, in the case of the short PUCCH, when the UE is located in the center of the UL coverage rather than the edge of the UL coverage, even if the sequence group used for the short PUCCH is configured in a UE-specific manner, interference may not occur or only a small degree of interferences may occur between the adjacent base stations. On the other hand, in the case of the long PUCCH, it may be preferable that the sequence group used for the long PUCCH is configured in a cell-specific manner, since the UE may cause interferences to the adjacent base stations although the UE is located in any position within the UL coverage.

A Case that UCI1 of PUCCH1 is Composed of 3 Bits or More

The above-described methods may be applied to a case where the UCI1 transmitted through the long PUCCH is composed of 3 bits or more and the UCI2 transmitted through the short PUCCH is composed of 1 bit or 2 bits. In order to transmit 3 bits or more as the UCI1, the UE may transmit the long PUCCH through channel coding. Hereinafter, a case where two or less bits are transmitted as the UCI2 may be considered.

In this case, a bandwidth occupied by the long PUCCH may be configured based on a value determined by the serving base station. For example, in case of a PUCCH format 3 of the NR system, the long PUCCH may have the bandwidth corresponding to the number of PRBs corresponding to one of {1,2,3,4,5,6, 8,9,10, 12,15,16}. In case of a PUCCH format 4, the long PUCCH may have the bandwidth corresponding to 1 PRB.

The method proposed in the embodiment of the present disclosure is a method of changing the DM-RS sequence used in the DM-RS symbol to additionally transmit the UCI2 through the long PUCCH, and allowing the serving base station to detect the value of the UCI2 through the changed DM-RS sequence. The UE may further transmit the UCI2 on the long PUCCH from a symbol index set defined in the standard, or may transmit the UCI2 on the long PUCCH from a symbol index set configured by an upper layer signaling (e.g., RRC signaling) from the serving base station.

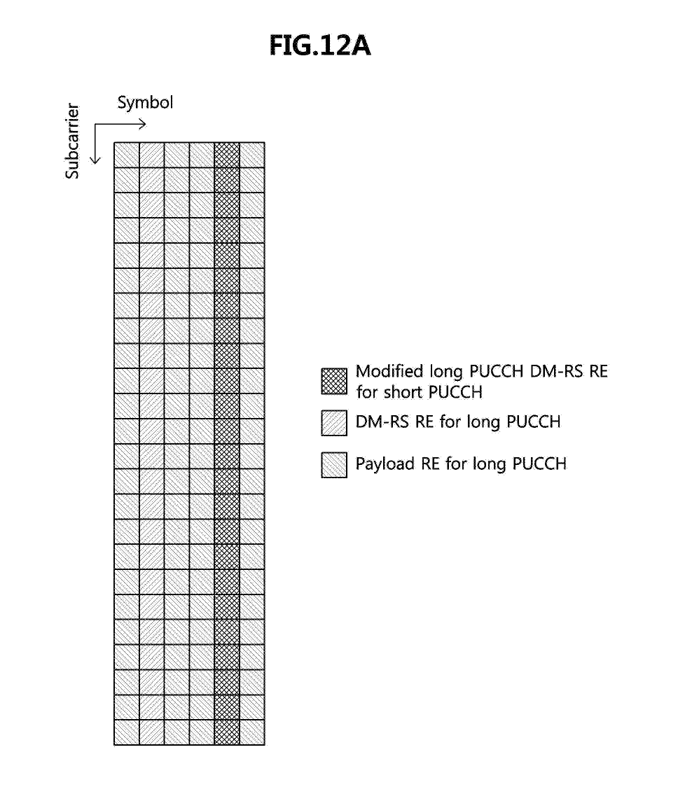

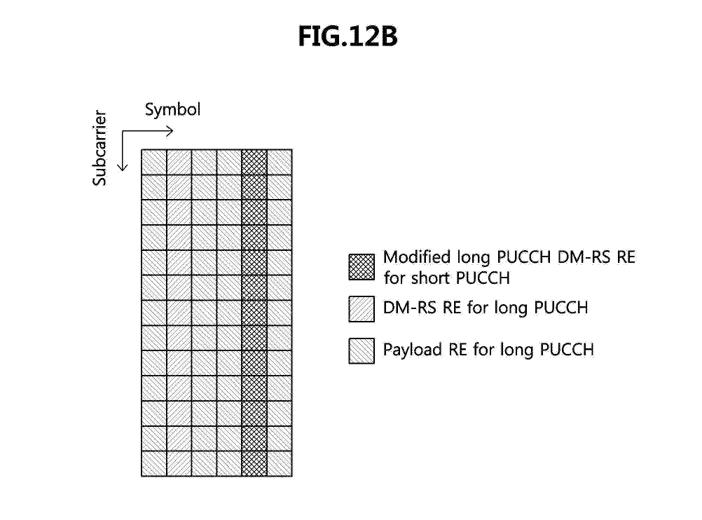

FIGS. 12A and 12B are conceptual diagrams for explaining resource structures when a long PUCCH and a short PUCCH are multiplexed according to yet another embodiment of the present disclosure.

Referring to FIG. 12A, the long PUCCH format 3 occupying 6 symbols and 2 PRBs for the case where a frequency hopping is not applied is illustrated. In the illustrated resources, the DM-RS symbols may be transmitted at the second symbol position (index 1) and the fifth symbol position (index 4). The UCI1 may be represented by 3 or more bits, the UCI2 may be represented by 1 or 2 bits, and they may be transmitted at the fifth symbol position (index 4).

The UE may generate the DM-RS sequence for the DM-RS symbol transmitted at the fifth symbol position, and then change the cyclic shift of the generated DM-RS sequence by δ according to the value of 1 bit or 2 bits of UCI2. For example, with respect to the predetermined cyclic shift value α, in the case where the UCI2 is composed of 1 bit, δ may be determined to be one of {0,6} (i.e., δ ∈ {0,6}), and in the case where the UCI2 is composed of 2 bits, δ may be determined to be one of {0,3,6,9} (i.e., δ ∈ {0,3,6,9}).

Meanwhile, when the UCI2 is composed of 3 bits or more, the serving base station may instruct the UE to compress the UCI2 to 2 bits or less. For example, the serving base station may instruct the UE to apply a HARQ-ACK bundling or the like.

Referring to FIG. 12B, the long PUCCH format 4 occupying 6 symbols and 1 PRB for the case where a frequency hopping is not applied is illustrated. In the illustrated resources, the DM-RS symbols may be transmitted at the second symbol position (index 1) and the fifth symbol position (index 4). The UCH may be represented by 3 or more bits, the UCI2 may be represented by 1 or 2 bits, and they may be transmitted at the fifth symbol position (index 4). Meanwhile, when the UCI2 is composed of 3 bits or more, the serving base station may instruct the UE to compress the UCI2 to 2 bits or less. For example, the serving base station may instruct the UE to apply a HARQ-ACK bundling or the like.

After generating the DM-RS sequence for the DM-RS symbol transmitted at the fifth symbol position (index 4), the UE may change the cyclic shift of the generated DM-RS sequence by δ according to the value of 1 bit or 2 bits of UCI2. For example, with respect to the predetermined cyclic shift value α, in the case where the UCI2 is composed of 1 bit, δ may be determined to be one of {0,6} (i.e., δ ∈ {0,6}), and in the case where the UCI2 is composed of 2 bits, δ may be determined to be one of {0,3,6,9} (i.e., δ ∈ {0,3,6,9}).

The serving base station may configure the UE to transmit the UCI2 using only the second DM-RS symbol (i.e., the DM-RS symbol transmitted at the fifth symbol position) in the long PUCCH. In this way, the serving base station may not assume that the DM-RS sequence may be changed in all the DM-RS symbols, but perform a hypothesis testing on only for the DM-RS sequence of some DM-RS symbols (i.e., the second DM-RS symbol).

The UE may generate the first DM-RS symbol (i.e., the DM-RS symbol transmitted at the second symbol position) without considering the UCI2, and generate the modified DM-RS sequence for the second DM-RS symbol through a base sequence hopping or a cyclic shift change according to the UCI2. The serving base station may estimate a UL CSI using the first DM-RS symbol and detect the UCI2 using the second DM-RS symbol.

Here, as a method of changing the DM-RS sequence of the second DM-RS symbol, when UCI2 is composed of 1 bit or 2 bits, a method similar to the method described in FIGS. 12A and 12B may be applied. However, unlike the method described in FIGS. 12A and 12B, a set of some DM-RS symbols whose DM-RS sequence is to be changed may be determined by using a predetermined value in the standard or a value transmitted from the serving base station via an upper layer signaling, and the UE may change the DM-RS sequences of the corresponding DM-RS symbols.

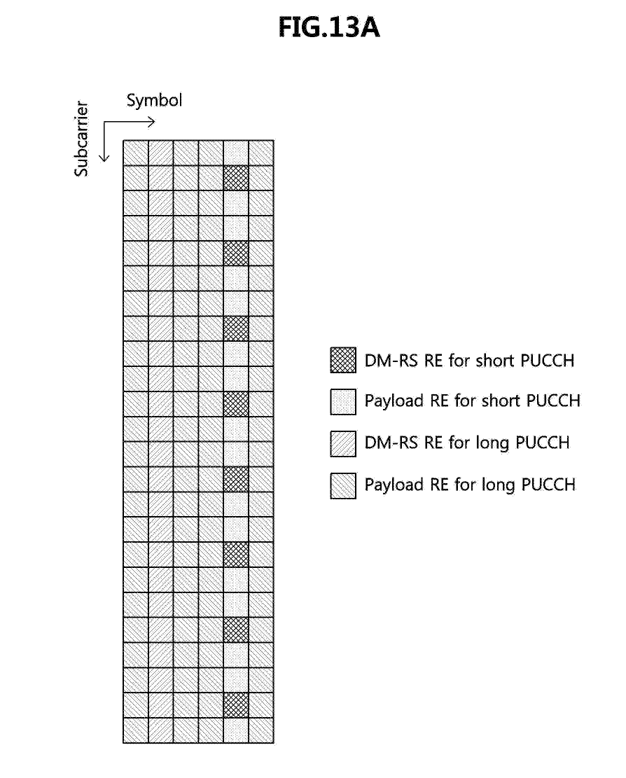

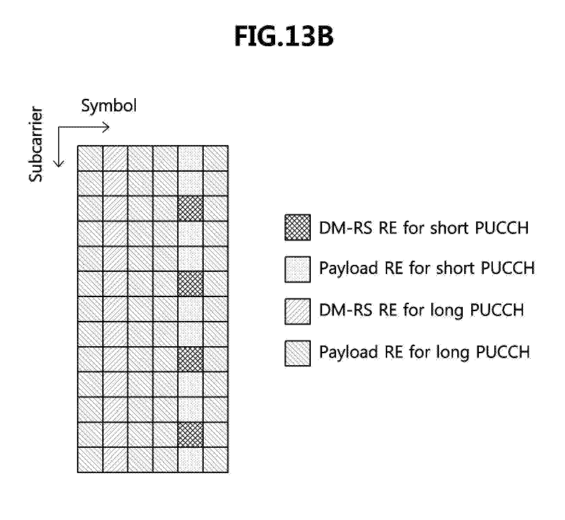

FIGS. 13A and 13B are conceptual diagrams for explaining resource structures when a long PUCCH and a short PUCCH are multiplexed according to still yet another embodiment of the present disclosure.

In case that the UCI2 is composed of 3 bits or more, the method described with reference to FIGS. 13A and 13B may be applied.

Referring to FIG. 13A, a case in which the short PUCCH is transmitted instead of the DM-RS symbol at the fifth symbol position (index 4) with respect to the PUCCH format 3 using 6 symbols and 2 PRBs is illustrated. Meanwhile, referring to FIG. 13B, a case in which the short PUCCH is transmitted instead of the DM-RS symbol at the fifth symbol position (index 4) with respect to the PUCCH format 4 using 6 symbols and 1 PRB.

In the above cases, the short PUCCH may be configured to be transmitted using one symbol, the DM-RS may be allocated to some subcarriers of the one symbol, and the encoded UCI2 payload may be allocated to the remaining subcarriers. Therefore, the serving base station may obtain the UL CSI using both the DM-RS of the short PUCCH and the DM-RS of the long PUCCH. The serving base station may obtain the UL CSI, and then obtain both the UCI1 and the UCI2 through an appropriate decoding procedure.

In yet another embodiment of the present disclosure, the serving base station may configure the UE to transmit the short PUCCH only at some symbol positions of the long PUCCH, but may also allow the UE to transmit the short PUCCH at all DM-RS symbol positions. In this case, the serving base station should acquire the UL CSI considering the case where the UCI2 does not exist and the case where the UCI2 exists for each DM-RS symbol.

The serving base station may instruct the two or more UEs to transmit the PUCCH in the same PRB(s). When two or more UEs transmit each long PUCCH, since the same DM-RS structure and spreading structure as described above are applied, interferences between the long PUCCHs from two UEs may be cancelled by using a correlation property of sequences. Accordingly, the serving base station may use the same interference cancellation algorithm applied when only the UCI 1 is transmitted, irrespective of the presence of the UCI 2.

Timing Relationship Between URLLC PDSCH and PUCCH

In the 3GPP NR-based system, when the UE receives less than 5 layers of URLLC PDSCH, the UE may generate a HARQ-ACK composed of 1 bit. In this case, the UE may transmit a short PUCCH by selecting one of two sequences corresponding to a 1-bit value. Also, when the UE receives two URLLC PDSCHs, the UE may select one of the four sequences corresponding to two HARQ-ACKs (i.e., 2 bits) for two URLLC PDSCHs, and process the two URLLC PDSCHs at the same short PUCCH timing. This is because, as shown in FIGS. 11A and 11B, the UCI2 is transmitted through two OFDM symbols. Here, each set of mini-slots of the DL URLLC PDSCH should correspond to the UL OFDM symbol index.

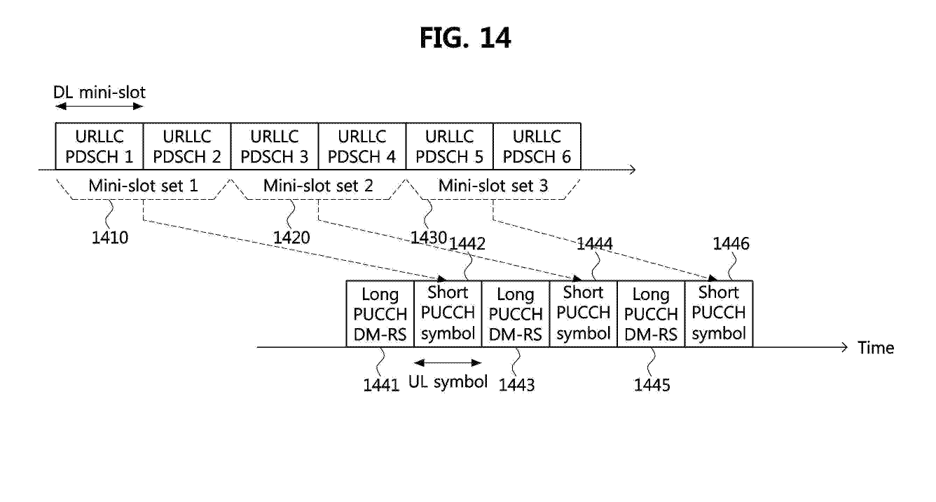

FIG. 14 is a conceptual diagram for explaining a correspondence relationship between URLLC PDSCH mini-slots and short PUCCH symbols.

Referring to FIG. 14, a case in which 3 mini-slot sets 1410, 1420 and 1430 each consisting of two URLLC PDSCHs are received, and HARQ-ACKs for the 3 mini-slot sets are transmitted through a long PUCCH consisting of 6 symbols is illustrated. In FIG. 14, in the long PUCCH, DM-RS symbols 1441, 1443, and 1445 and UCI payload symbols 1442, 1444, and 1446 are alternately configured. Each of the UCI payload symbols 1442, 1444, and 1446 may correspond to one mini-slot set.

Such the correspondence may be delivered to the UE via an RRC signaling or a combination of RRC signaling and DCI from the serving base station, or may be predetermined in the standard. In this case, each of the URLLC PDSCHs should have a different HARQ-ACK timing. For example, if a URLLC PDSCH1 belonging to the first mini-slot set 1410 has a HARQ-ACK symbol timing of (n+k+1), a URLLC PDSCH2 belonging to the same mini-slot set 1410 may have a HARQ-ACK symbol timing of (n+k).

Multiplexing of Scheduling Requests

The UE may receive a priority for a logical channel ID (LCID) from the serving base station, and transmit only one SR in one symbol without transmitting several SRs at a time. In this case, the SR may correspond to a long PUCCH or a short PUCCH in the serving base station.

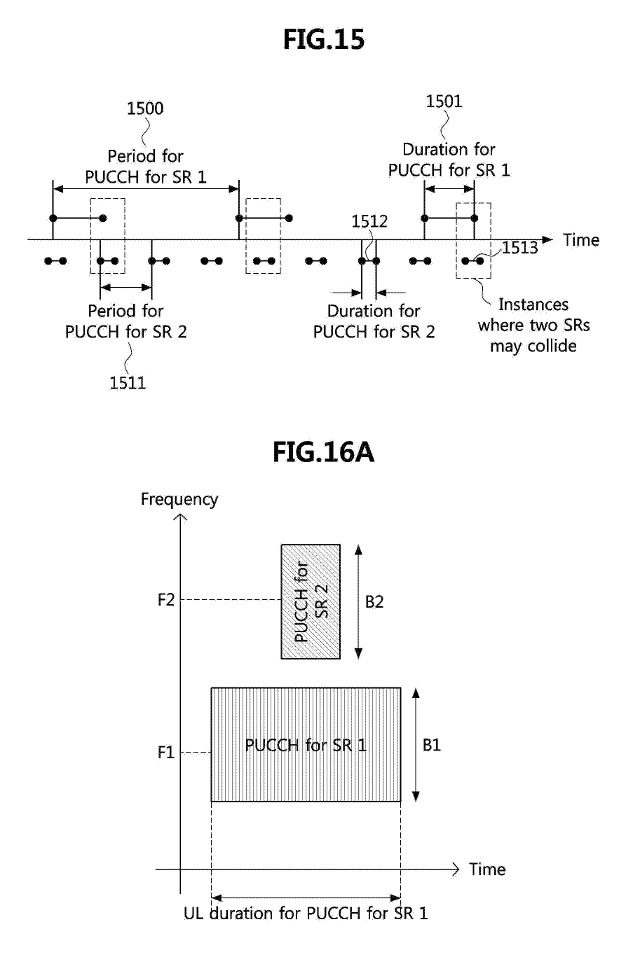

FIG. 15 is a conceptual diagram for explaining a situation in which transmission time points of PUCCHs including SRs having different priorities collide with each other.

Referring to FIG. 15, transmission intervals 1500 and 1501 of a PUCCH for SR1 and transmission intervals 1511, 1512 and 1513 for a PUCCH for SR2 may exist. As shown in FIG. 15, there may be a case where the PUCCH transmission interval 1501 for SR1 and the PUCCH transmission interval 1513 for SR2 collide. That is, a case may occur in which the SR2 to be transmitted on the short PUCCH should be transmitted while the SR1 is transmitted on the long PUCCH. For convenience of explanation, a SR having a lower priority but generated later is referred to as ‘SR1’, and a SR having a higher priority but generated earlier is referred to as ‘SR2’.

Therefore, a processing method in the case where an SR having a higher priority occurs later in time will be considered hereinafter.

As illustrated in FIG. 15, during transmission of the SR1, the UE may drop the transmission of the SR1 upon recognizing that the SR2 has been generated. That is, after transmitting only a part of the symbols constituting the PUCCH for SR1, the UE may stop the transmission of the PUCCH for SR1, wait for the transmission interval of the PUCCH for SR2, and then transmit the SR2 in the PUCCH transmission interval for SR2. Also, the UE may not transmit the PUCCH for SR1 even after transmitting the entire PUCCH for SR2. Meanwhile, if the UE does not complete the transmission at the boundary of the symbol, inter-subcarrier interference may occur. Therefore, the UE may continue to transmit to the boundary of the symbol and then transmit nothing until the PUCCH for SR 2 is transmitted. Also, the UE may not further transmit the PUCCH for SR1 even after transmitting the PUCCH for SR2.

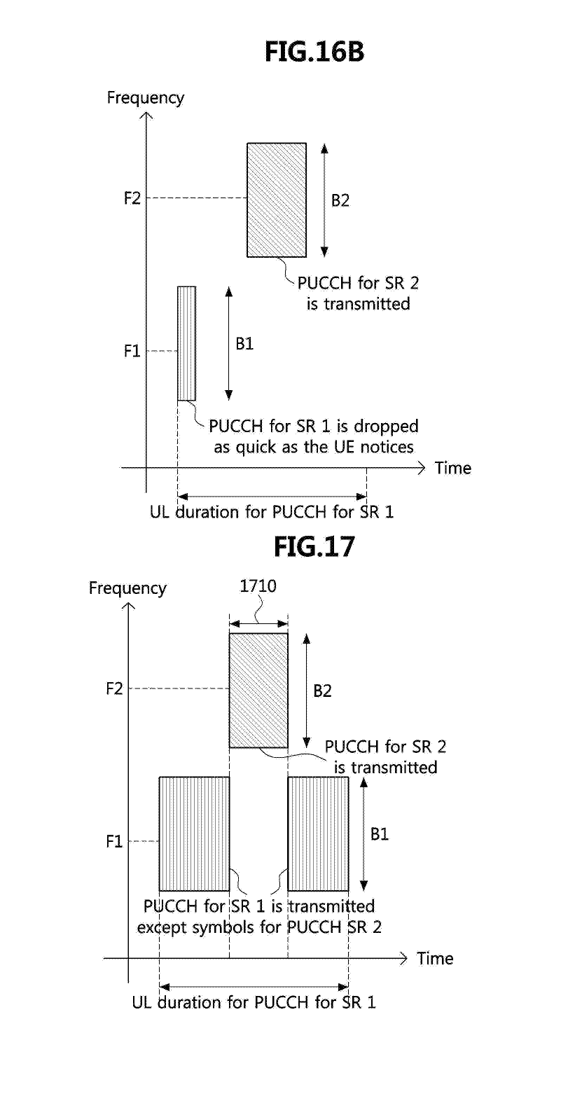

FIGS. 16A and 16B are conceptual diagrams for explaining a processing method according to an embodiment of the present disclosure when a transmission interval of a PUCCH for SR1 and a transmission interval of a PUCCH for SR2 are collided.

Referring to FIG. 16A, the UE may transmit the PUCCH for SR2 regardless of the presence of the PUCCH for SR1. In this case, since the serving base station detects the insufficient number of symbols in the resources of the PUCCH for SR1, it may be difficult for the serving base station to determine whether or not the UE has transmitted the PUCCH for SR1. On the other hand, the serving base station may determine whether or not the UE has transmitted the PUCCH for SR2 in the resources of the PUCCH for SR2.

Referring to FIG. 16B, the UE may transmit the PUCCH for SR2 considering the presence of the PUCCH for SR1. In this case, since the serving base station detects the insufficient number of symbols in the resources of the PUCCH for SR1, it may be difficult for the serving base station to determine whether or not the UE has transmitted the PUCCH for SR1. However, since the serving base station can identify that the UE is using the sequence allocated by the serving base station as the sequence of the PUCCH for the SR2 and the UE is using F1 as the center frequency, the serving base station may also identify that the PUCCH resources for the SR1 are used together. Therefore, the serving base station can determine that the UE is transmitting both the PUCCH for SR1 and the PUCCH for SR2.

As shown in FIG. 16B, if the bandwidths are kept to be the same (i.e., B1=B2) and the PUCCH for SR1 and the PUCCH for SR2 are transmitted using sequences of the same length, the serving base station may perform non-coherent detection with a lower complexity.

FIG. 17 is a conceptual diagram for explaining a processing method according to another embodiment of the present disclosure when a transmission interval of a PUCCH for SR1 and a transmission interval of a PUCCH for SR2 are collided.

Referring to FIG. 17, when the UE recognizes that SR2 has occurred during transmission of the PUCCH for SR1, the UE may transmit only symbol(s) of the PUCCH for the higher priority SR2 at symbol positions 1710 where symbols of the PUCCH for SR1 and symbols of the PUCCH for SR2 can exist together.

The UE may transmit the symbol of the PUCCH for SR1 to the serving base station only when the symbol of the PUCCH for SR1 does not overlap with the symbol of the PUCCH for SR2. In this case, if the long PUCCH for SR1 is not transmitted at the corresponding symbol position, the interference between the UEs is reduced, so that it becomes easier to demodulate the PUCCH from the multiplexed PUCCHs in the serving base station.

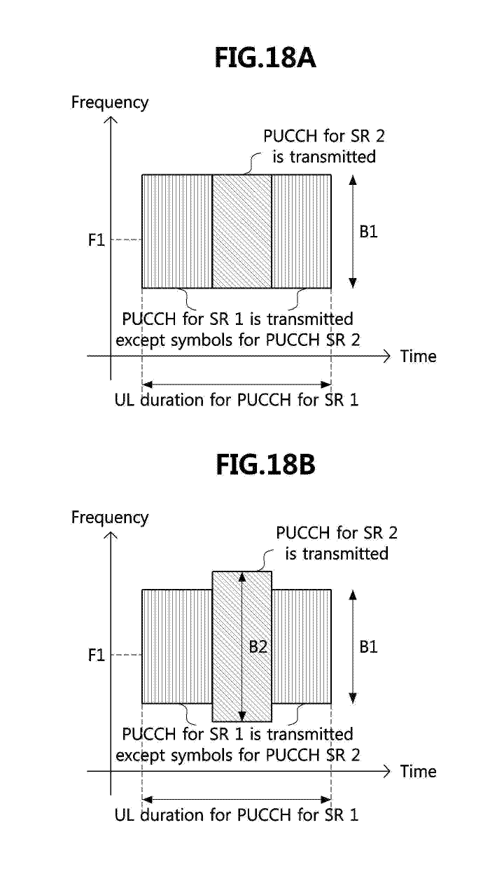

FIGS. 18A and 18B are conceptual diagrams for explaining a processing method according to yet another embodiment of the present disclosure when a transmission interval of a PUCCH for SR1 and a transmission interval of a PUCCH for SR2 are collided.

The frequency resource of the PUCCH for SR1 and the frequency resource of the PUCCH for SR2 may be configured to be overlapped with each other.

Referring to FIG. 18A, the long PUCCH for SR1 and the short PUCCH for SR2 may be configured to have the same center frequency F1 and the same bandwidth B1. On the other hand, referring to FIG. 18B, the long PUCCH for SR1 and the short PUCCH for SR2 may have the same center frequency F1 but different bandwidths B1 and B2. However, the serving base station may configure the center frequency and bandwidth differently for the UE.

If the serving base station detects a sequence for transmitting the SR2 in a part of the symbols, the serving base station may determine that the UE transmits the SR2. Also, if the serving base station detects a sequence for transmitting the SR1 in some symbols, the serving base station may determine that the UE transmits the SR1.

Here, the some symbols may be symbols configured by the serving base station to transmit the short PUCCH for SR2. Since the serving base station perform non-coherent detection on the sequences, it is preferable that the serving base station allocates the sequence allocated to the PUCCH for SR1 and the sequence allocated to the PUCCH for SR2 so that a cross-correlation therebetween is to be low.

UCI Transmission on PUSCH According to a Latency Requirement

As described above, the UE may transmit UCI using PUCCH or PUSCH. It is assumed that the UE does not simultaneously transmit the PUCCH and the PUSCH in order to obtain a small PAPR and a low maximum power reduction (MPR). In this case, the UE may transmit the UCI through the PUSCH.

In this case, it is possible to consider a method of mapping each UCI to REs of the PUSCH so as to satisfy latency requirements of type of each UCI. For example, the UCI may be mapped to the different number of REs, and RE mapping of the UCI on the PUSCH may be performed differently according to the type of UCI.

In case that the UCI is composed of 1-bit or 2-bit HARQ-ACK, the UCI may be transmitted by puncturing the REs of the PUSCH. In case that the UCI is composed of HARQ-ACKs of 3 bits or more, the UCI may be transmitted by rate matching with a payload of the PUSCH on the REs of the PUSCH. The HARQ-ACK UCI may be mapped to the REs of the PUSCH in a distributive manner over the frequency domain. In case of the CSI UCI, the REs of the PUSCH may be rate-matched, and then the CSI UCI may be mapped to the REs of the PUSCH in a distributive manner over the frequency domain.

Each bit of the HARQ-ACK UCI may be either a HARQ-ACK for an eMBB PDSCH or a HARQ-ACK for a URLLC PDSCH, and may be classified according to a latency requirement or a HARQ-ACK timing. In case that the UE has several latency requirements, it is preferable to reflect the requirement in the RE mapping of the UCI on the PUSCH.

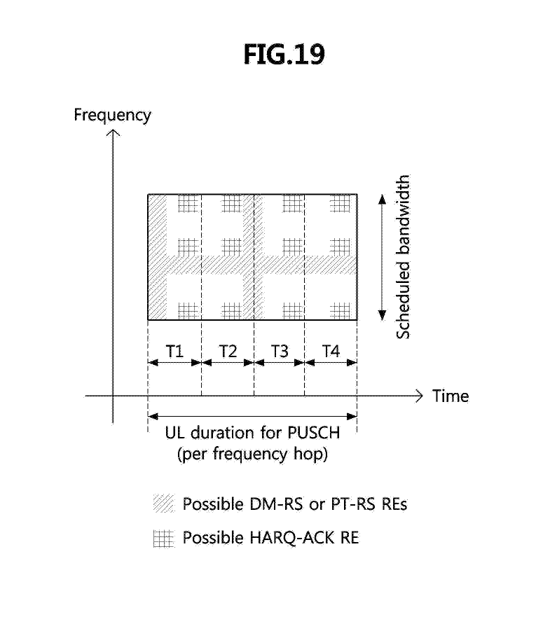

FIG. 19 is a conceptual diagram for explaining a method of mapping UCIs having different latency requirements on PUSCH REs according to an embodiment of the present disclosure.

Referring to FIG. 19, a case in which HARQ-bits having four different latency requirements are scheduled by the serving base station to be transmitted through a PUSCH is illustrated. The serving base station may transmit four or more TBs to the UE and indicate the timing of transmitting the HARQ-ACK for each TB. Such HARQ-ACK timing may be indicated by slot unit, mini-slot unit, or symbol unit.

FIG. 19 illustrates a HARQ-ACK for the first TB to be transmitted in an interval T1, a HARQ-ACK for the second TB to be transmitted in an interval T2, a HARQ-ACK for the third TB to be transmitted in an interval T3, and a HARQ-ACK for the fourth TB to be transmitted in an interval T4. The UE may transmit each HARQ-ACK bit according to the specific time interval by mapping each HARQ-ACK bit to the REs of the PUSCH so as to satisfy the latency requirement of each HARQ-ACK bit.

When a plurality of HARQ-ACK bits are transmitted in the same time interval, the plurality of HARQ-ACK bits may be independently encoded or jointly encoded. When the plurality of HARQ-ACK bits are independently encoded, the UE may spread or repeat each HARQ-ACK bit, map it to a modulation symbol, and perform mapping of it onto the REs of the PUSCH. Here, a spreading factor, a repetition number, or a modulation order may be applied based on values indicated by the serving base station via a PDCCH (i.e., DCI) and/or an RRC signaling. When the plurality of HARQ-ACK bits are jointly encoded, the UE may map channel-coded HARQ-ACK bits to modulation symbols and perform mapping of the channel-coded HARQ-ACK bits onto the REs of the PUSCH. In this case, a code rate and a modulation order may be applied based on values indicated by the serving base station via a PDCCH (i.e., DCI) and/or an RRC signaling.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal for transmitting uplink control information (UCI) to a base station by multiplexing two or more UCIs in a single physical uplink control channel (PUCCH), the operation method comprising:
determining a first sequence corresponding to a value of a second UCI (UCI2) when the UCI2 is generated before completing transmission of a first UCI (UCI1) to the base station;
modulating the first sequence by applying a modulation symbol corresponding to a value of the UCI1, and applying a orthogonal cover code (OCC) to the modulated first sequence to generate a second sequence; and
transmitting the second sequence in at least one symbol position of symbols constituting the PUCCH.

2. The operation method according to claim 1, wherein the first sequence is determined by applying a cyclic shift corresponding to the value of the UCI2 to a base sequence selected based on a value received from the base station via a radio resource control (RRC) signaling and/or a downlink control information (DCI).

3. The operation method according to claim 1, wherein the UCI2 is a hybrid automatic repeat request acknowledgement (HARQ-ACK) information for a ultra-reliable low-latency communication (URLLC) physical downlink shared channel (PDSCH), when the UCI1 is a HARQ-ACK information for an enhanced mobile broadband (eMBB) PDSCH.

4. The operation method according to claim 3, wherein the at least one symbol position is indicated by the base station via a RRC signaling, or is selected by a downlink control information (DCI) among two or more values indicated via a RRC signaling.

5. The operation method according to claim 1, wherein the PUCCH has a long PUCCH structure in which demodulation reference (DM-RS) symbols and UCI payload symbols are located alternately.

6. The operation method according to claim 5, wherein the at least one symbol position indicates one of the UCI payload symbols, and the second sequence is transmitted together with a DM-RS sequence in a position of the one of UCI payload symbols.

7. The operation method according to claim 5, wherein the at least one symbol position indicates one of the UCI payload symbols, the second sequence is transmitted in a position of the one of the UCI payload symbols, and the second sequence performs a role of DM-RS.

8. The operation method according to claim 5, wherein the at least one symbol position indicates one of the DM-RS symbols and one of the UCI payload symbols, a long PUCCH DM-RS sequence to which a cyclic shift corresponding to the value of the UCI2 is applied is transmitted in a position of the one of the DM-RS symbols, and the second sequence is transmitted in a position of the one of the UCI payload symbols.

9. An operation method of a base station for receiving two or more uplink control information (UCI) multiplexed in a single physical uplink control channel (PUCCH) from a terminal, the operation method comprising:
receiving a signal of the PUCCH from the terminal;
attempting to detect a long PUCCH demodulation reference signal (DM-RS) from the signal of the PUCCH;
detecting a second UCI (UCI2) by detecting a sequence corresponding to the UCI2 from at least one symbol position of symbols constituting the PUCCH, when the long PUCCH DM-RS is detected; and
detecting a first UCI (UCI1) by despreading the signal of the PUCCH and demultiplexing the UCI1 by using an orthogonal cover code (OCC) applied to the UCI1, when the UCI1 is detected.

10. The operation method according to claim 9, wherein the UCI2 is a hybrid automatic repeat request acknowledgement (HARQ-ACK) information for a ultra-reliable low-latency communication (URLLC) physical downlink shared channel (PDSCH), when the UCI1 is a HARQ-ACK information for an enhanced mobile broadband (eMBB) PDSCH.

11. The operation method according to claim 9, wherein the PUCCH has a long PUCCH structure in which demodulation reference (DM-RS) symbols and UCI payload symbols are located alternately.

12. The operation method according to claim 11, wherein the at least one symbol position indicates one of the UCI payload symbols, and the sequence corresponding to the UCI2 is detected together with a DM-RS sequence in a position of the one of UCI payload symbols.

13. The operation method according to claim 11, wherein the at least one symbol position indicates one of the UCI payload symbols, the sequence corresponding to the UCI2 is detected in a position of the one of the UCI payload symbols, and the sequence corresponding to the UCI2 performs a role of DM-RS.

14. The operation method according to claim 11, wherein the at least one symbol position indicates one of the DM-RS symbols and one of the UCI payload symbols, a long PUCCH DM-RS sequence to which a cyclic shift corresponding to the value of the UCI2 is applied is detected at a position of the one of the DM-RS symbols, and the sequence corresponding to the UCI2 is detected in a position of the one of the UCI payload symbols.

15. A terminal for transmitting uplink control information (UCI) to a base station by multiplexing two or more UCIs in a single physical uplink control channel (PUCCH), the terminal comprising at least one processor, a memory storing at least one instruction executed by the at least one processor, and a transceiver controlled by the at least one processor, wherein the at least one instruction is configured to:
determine a first sequence corresponding to a value of a second UCI (UCI2) when the UCI2 is generated before completing transmission of a first UCI (UCI1) to the base station;
modulate the first sequence by applying a modulation symbol corresponding to a value of the UCI1, and apply a orthogonal cover code (OCC) to the modulated first sequence to generate a second sequence; and
transmit the second sequence in at least one symbol position of symbols constituting the PUCCH through the transceiver.

16. The terminal according to claim 15, wherein the first sequence is determined by applying a cyclic shift corresponding to the value of the UCI2 to a base sequence selected based on a value received from the base station via a radio resource control (RRC) signaling and/or a downlink control information (DCI).

17. The terminal according to claim 15, wherein the UCI2 is a hybrid automatic repeat request acknowledgement (HARQ-ACK) information for a ultra-reliable low-latency communication (URLLC) physical downlink shared channel (PDSCH), when the UCI1 is a HARQ-ACK information for an enhanced mobile broadband (eMBB) PDSCH.

18. The terminal according to claim 15, wherein the PUCCH has a long PUCCH structure in which demodulation reference (DM-RS) symbols and UCI payload symbols are located alternately.

19. The terminal according to claim 18, wherein the at least one symbol position indicates one of UCI payload symbols, and the second sequence is transmitted together with a DM-RS sequence in a position of the one of UCI payload symbols, or transmitted in a position of the one of the UCI payload symbols by performing a role of DM-RS.

20. The terminal according to claim 18, wherein the at least one symbol position indicates one of the DM-RS symbols and one of the UCI payload symbols, a long PUCCH DM-RS sequence to which a cyclic shift corresponding to the value of the UCI2 is applied is transmitted in a position of the one of the DM-RS symbols, and the second sequence is transmitted in a position of the one of the UCI payload symbols.
